(19) United States
(12) Patent Application Publication
(10) Pub. No.: US 2025/0268275 A1
(43) Pub. Date: Aug. 28, 2025

(54) Premix Energy Blend

(71) Applicant: Starbucks Corporation, Seattle, WA (US)

(72) Inventors: Manpreet Kaur Cheema, Maple Valley, WA (US); Emily S. Fazio, Seattle, WA (US); Kristin T. Murray, Seattle, WA (US); Debra Marie Ismon Antonio, Bellevue, WA (US); Marvin Jiwan, Bonney Lake, WA (US); Diane D. Terry, Seattle, WA (US)

(21) Appl. No.: 19/064,579

(22) Filed: Feb. 26, 2025

Related U.S. Application Data
(60) Provisional application No. 63/558,409, filed on Feb. 27, 2024.
(60) Provisional application No. 63/707,086, filed on Oct. 14, 2024.

(51) Int. Cl. A23F 5/02; A23F 3/16; A23F 5/24; A23L 33/105; A23L 33/125; A23L 33/15; A23L 33/175

(52) U.S. Cl. CPC A23F 5/02; A23F 3/163; A23F 5/243; A23L 33/105; A23L 33/125; A23L 33/15; A23L 33/175

(57) ABSTRACT

The disclosure relates to compositions comprising low levels of caffeine (e.g., 25 wt % or less), wherein the composition contains a natural caffeine source in combination with antioxidants, vitamins, electrolytes, and/or amino acids. The disclosed composition, which is made up of natural ingredients, beneficially offers a holistic approach to physical and mental energy. This abstract is intended as a scanning tool for purposes of searching in the particular art and is not intended to be limiting of the present disclosure.

### CROSS-REFERENCE TO RELATED APPLICATIONS

This Application claims the benefit of U.S. Application No. 63/707,086, filed on Oct. 14, 2024, and U.S. Application No. 63/558,409, filed on Feb. 27, 2024, the contents of each of which are incorporated herein by reference in their entireties.

### BACKGROUND

Caffeine is the world's most popular stimulant, with an estimated yearly global consumption of 120,000 tons. Caffeine has long been consumed throughout history as a wakefulness promoter or as a mild cognitive enhancer to increase alertness and attentional performance. Coffee, tea, soft drinks, and energy drinks are popular sources of caffeine across all age groups.

In particular, energy drinks have become a popular beverage of choice for individuals seeking a quick energy boost, and are especially popular among young people. The majority of energy drinks on the market contain synthetic caffeine, or caffeine produced in a laboratory rather than extracted from a natural source of caffeine. Although synthetic caffeine is chemically identical to natural caffeine, recent studies have shown that synthetic caffeine is absorbed into the body more rapidly than natural caffeine, and can lead to a peak in energy followed by a steep crash. Furthermore, production of synthetic caffeine involves the use of chemicals and solvents that can be harmful to both human health and the environment.

More recently, the demand for beverages that enhance physical and mental wellness, in addition to providing caffeine for energy, has increased. Typically, these energy drinks include ingredients such as taurine, panax ginseng, and B-vitamins to support energy levels and energy metabolism (physical performance). Alternative beverages incorporate electrolyte salts to prodive hydration support. In both cases, the drinks rely on excessive amounts of caffeine (90% or greater) or synthetic caffeine, which detracts from their wellness benefits.

In addition to the high caffeine levels, energy drinks also typically contain large quantities of sugar, which is a health concern. Research has linked regular consumption of energy drinks to an increased risk of developing chronic health diseases such as obesity and type 2 diabetes.

Energy drinks are typically produced as shelf-stable formulations. As such, they often contain additives, preservatives, as well as artificial colors and flavors to increase or maintain shelf stability. These additives can negate or diminish the health benefits these beverages purport to offer. Moreover, when these drinks are provided as a dry powder premix to be added to liquid, the artificial dyes and flavors impart a particular color, taste, and mouth feel, which limits the utility of these blends to combinations with water, as mixing them with alternative beverages would affect the color and flavor of the resulting beverage.

Despite the popularity of energy drinks and other wellness drinks, the development of a natural energy blend that maximizes functional benefits without imparting on off-taste, color, or mouthfeel to the final beverage product has remained elusive. Thus, there remains a need for energy blends that combine low levels of natural caffeine with other natural ingredients that impart metabolic energy, immunity, hydration, and other health benefits. These needs and others are met by the present invention.

### SUMMARY

In accordance with the purpose(s) of the invention, as embodied and broadly described herein, the invention, in one aspect, relates to compositions comprising low levels of caffeine (e.g., 10 wt % or less), wherein the composition contains a natural caffeine source in combination with antioxidants, vitamins, electrolytes, and/or amino acids. The disclosed composition, which is made up of natural ingredients, beneficially offers a holistic approach to physical and mental energy. Functional benefits including increased metabolic energy, enhanced immunity, mental focus, calm, and anti-inflammatory properties are maximized, while the “instant jolt” and jitteriness commonly found with energy beverages appears dimished. In addition, the disclosed composition imparts little to no aftertaste and results in a highly soluble, clear, colorless, and flavorless solution upon mixing in a beverage.

Thus, disclosed are compositions comprising a natural caffeine source comprising: (a) caffeine and one or more polyphenols; (b) one or more antioxidants or sources thereof; (c) one or more vitamins or sources thereof; and (d) one or more additives selected from: (i) one or more electrolytes or sources thereof; and (ii) one or more amino acids or sources thereof, wherein each of the natural caffeine source, the one or more antioxidants or sources thereof, the one or more vitamins or sources thereof, and the one or more additives are different, and wherein the composition comprises 25 wt % or less caffeine.

Also disclosed are beverages comprising a disclosed composition.

Also disclosed are kits comprising a disclosed composition and a beverage.

Also disclosed are liquid concentrates comprising water and a disclosed composition.

Also disclosed are beverages comprising a disclosed liquid concentrate.

Also disclosed are kits comprising a disclosed liquid concentrate and a beverage.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIG. 1 shows representative photographs of exemplary Formulation 1A-4 (righthand photo), in which a disclosed energy blend composition is dissolved in water, and alternative formulation 1A-0 (lefthand photo), illustrating the improved solubility and clarity achieved via selection of the electrolyte salt anion.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

The present invention can be understood more readily by reference to the following detailed description of the invention and the Examples included therein.

Before the present compositions, liquid concentrates, and/or beverages are disclosed and described, it is to be understood that they are not limited to specific methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Disclosed are the components to be used to prepare the compositions, liquid concentrates, and/or beverages of the invention as well as the compositions, liquid concentrates, and/or beverages themselves to be used within the methods disclosed herein. These and other materials are disclosed herein, and it is understood that when combinations, subsets, interactions, groups, etc. of these materials are disclosed that while specific reference of each various individual and collective combinations and permutation of these capsules cannot be explicitly disclosed, each is specifically contemplated and described herein. For example, if a particular composition is disclosed and discussed and a number of modifications that can be made to a number of materials including the compositions are discussed, specifically contemplated is each and every combination and permutation of the composition and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including steps in methods of making and using the capsules and compositions of the invention. Thus, if there are a variety of additional steps that can be performed it is understood that each of these additional steps can be performed with any specific embodiment or combination of embodiments of the methods of the invention.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation.

### A. Definitions

As used in the specification and the appended claims, the singular forms “a,” “an” and “the” include plural referents unless the context clearly dictates otherwise. Thus, for example, reference to “a composition,” “a liquid concentrate,” or “a beverage” includes mixtures of two or more such compositions, liquid concentrates, beverages, and the like.

References to a composition, a liquid concentrate, or a beverage containing “an” ingredient is intended to include other ingredients, respectively, in addition to the one named.

By “comprising” or “containing” or “having” it is intended that at least the named component, element, material, or method step, etc., is present in the composition, liquid concentrate, or beverage, but does not exclude the presence of other components, elements, materials, method steps, etc., even if the other such components, elements, materials, method steps, etc., have the same function as what is named, unless expressly excluded in the claims.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance may or may not occur, and that the description includes instances where said event or circumstance occurs and instances where it does not.

As used herein, the term “beverage” refers to a liquid good or product that is intended for consumption by, for example, a human. Examples of beverages include, but are not limited to, carbonated beverages such as colas, lemon-lime sodas, fruit-flavored sodas, root beers, ginger ales, seltzers, tonic waters, beers, and sparkling waters. Further exemplary beverages suitable for the compositions disclosed herein include juices, fruit-flavored waters, still waters, teas, and smoothies.

As used herein, the term “liquid concentrate” refers to a food or beverage product in which a solute (e.g., a composition as disclosed herein) is dissolved in a solvent such as, for example, water, to form a homogenous mixture in which the concentration of the solute is at or near its maximum possible value. As would be understood by one of skill in the art, the solute concentration is defined as the amount of mass (grams) of the solute per unit volume (liters) of solution. The maximum possible solute concentration in a given solution is called the solute solubility. Said differently, the solubility of a solute is the maximum amount that can be dissolved in the solution. Thus, in various aspects, the liquid concentrate has a concentration of at least about 10%, at least about 20%, at least about 25%, at least about 30%, at least about 40%, at least about 50%, at least about 60%, at least about 70%, at least about 75%, at least about 80%, at least about 90%, or greater than 90%.

As used herein, the term “carbonated beverage” refers to a beverage in which dissolved carbon dioxide gas has been added, typically for enhancement of flavor or texture. Carbonated beverages include, but are not limited to, cola, lemon-lime soda, root beer, ginger ale, fruit-flavored sodas, seltzers, tonic water, beers, and sparkling waters.

### B. Compositions

In one aspect, disclosed are compositions comprising: (a) a natural caffeine source comprising caffeine and one or more polyphenols; (b) one or more antioxidants or sources thereof; (c) one or more vitamins or sources thereof; (d) one or more additives selected from: (i) one or more electrolytes or sources thereof; and (ii) one or more amino acids or sources thereof, wherein each of the natural caffeine source, the one or more antioxidants or sources thereof, the one or more vitamins or sources thereof, and the one or more additives are different, and wherein the composition comprises wt % or less caffeine.

In various aspects, the disclosed composition can be prepared as a dry powder mix. In this way, the dry powder mix is easily dissolved in a liquid to form a liquid mixture or a liquid concentrate. The resulting liquid mixture or liquid concentrate can be taste and odor neutral, and, thus, can beneficially be added to a desired beverage without imparting additional flavors or odors to the beverage. Furthermore, the dry powder mix is prepared such that it has a high solubility in the liquid, with little to no precipitation of the composition components. Thus, in one aspect, the disclosed composition can be reconstituted as a liquid before consumption. In a further aspect, the liquid is water. It is understood that the liquid can be hot or cold.

Known energy products typically rely on either natural caffeine powders that contain around 90% caffeine or more, or, alternatively, rely on synthetic caffeine powders. In both cases, caffeine is used as the main active ingredient. In contrast, the disclosed energy compositions incorporate a natural caffeine source (e.g., from green coffee beans, green tea, roasted white coffee), which provides only minimal caffeine (green coffee beans and green tea afford extracts that are less than 50% caffeine and white coffee contains around 5.5% caffeine), a balance of chlorogenic acids, and epigallocatechin gallate (EGCG) polyphenols.

The majority of energy products on the market contain synthetic caffeine, or caffeine produced in a laboratory, rather than caffeine extracted from a natural source. This is likely due to the fact that synthetic caffeine is both cheaper to produce and chemically identical to natural caffeine. However, recent studies have shown that synthetic caffeine is absorbed into the body more rapidly than natural caffeine, and can lead to a peak in energy followed by a steep crash. Furthermore, production of synthetic caffeine involves the use of chemicals and solvents that can be harmful to both human health and the environment. Thus, in various aspects, the composition does not contain a synthetic caffeine.

In various aspects, the composition consists essentially of the natural caffeine source, the one or more antioxidants or sources thereof, the one or more vitamins or sources thereof, and the one or more additives.

In various aspects, the composition consists of the natural caffeine source, the one or more antioxidants or sources thereof, the one or more vitamins or sources thereof, and the one or more additives.

In various aspects, the composition comprises: (a) the natural caffeine source selected from a green tea extract, a green coffee extract, and a white coffee, or a combination thereof; (b) one or more antioxidants or sources thereof selected from guarana extract, ginseng extract, and a blueberry juice powder, or a combination thereof; (c) one or more vitamins or sources thereof selected from acerola juice or juice extract, vitamin C or a synthetic version thereof, vitamin B12 or a synthetic version thereof, vitamin B3 or a synthetic version thereof, and vitamin B6 or a synthetic version thereof, or a combination thereof; and (d) one or more additives selected from: (i) one or more electrolytes or sources thereof selected from one or more sodium salts, one or more potassium salts, one or more magnesium salts, one or more calcium salts, and coconut water or water powder, or a combination thereof; and (ii) one or more amino acids or sources thereof selected from L-theanine, L-tyrosine, L-valine, L-leucine, and L-isoleucine, or a combination thereof.

In various aspects, the composition comprises: (a) the natural caffeine source selected from a green tea extract, a green coffee extract, and a white coffee, or a combination thereof; (b) guarana extract and ginseng extract; (c) one or more vitamins or sources thereof selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof; and (d) one or more electrolytes or sources thereof selected from one or more sodium salts, one or more potassium salts, one or more magnesium salts, one or more calcium salts, and coconut water or water powder, or a combination thereof.

In various aspects, the composition comprises: (a) the natural caffeine source selected from a green tea extract, a green coffee extract, and a white coffee, or a combination thereof; (b) one or more antioxidants or sources thereof selected from guarana extract, ginseng extract, and a blueberry juice or juice powder, or a combination thereof; (c) one or more vitamins or sources thereof selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof; and (d) one or more amino acids or sources thereof selected from theanine, tyrosine, isoleucine, leucine, and valine, or a combination thereof.

In one aspect, the composition further comprises a stabilizer. As detailed herein, a stabilizer is a component added to help maintain a stable emulsion and prevent degradation. In a further aspect, the stabilizer is selected from pectin, maltodextrin, a modified starch, a hydrocolloid (e.g., xanthan, gum Arabic, gum acacia), carrageenan, casein, and inulin, or a combination thereof. In a yet further aspect, the stabilizer is selected from pectin and maltodextrin, or a combination thereof. In a still further aspect, the stabilizer is pectin.

In one aspect, the composition further comprises a bulking agent. As detailed herein, a bulking agent is a component added to increase the volume and/or weight of a food product while keeping its utility and functionality intact and not imparting a taste. In various aspects, the bulking agent is selected from maltodextrin and dextrose, or combination thereof. In a further aspect, the bulking agent is maltodextrin. In a still further aspect, the bulking agent is dextrose. In a yet further aspect, the bulking agent is a combination of maltodextrin and dextrose.

In various aspects, the composition does not contain citicoline, choline, methylliberine, turmeric, rhodiola rosea, schisandra berry, or ginger root.

In various aspects, the composition does not contain one or more selected from a synthetic caffeine, chromium, citrulline, creatine, inositol, sucralose, erythritol, acesulfame potassium, citicoline, choline, methylliberine, turmeric, rhodiola rosea, schisandra berry, ginger root, a flavorant, and a colorant.

Chromium is an essential trace mineral that normalizes blood sugar levels and can help to enhance the metabolism of proteins, carbohydrates, and lipids. Thus, alternative energy beverages sometimes include an appetite suppressant such as chromium to aid consumers in weight loss and weight maintenance. Unfortunately, chromium may increase the risk of kidney or liver damage, and could interact with certain medications. Thus, in various aspects, the composition does not contain an appetite suppressant (e.g., chromium). In a further aspect, the composition does not contain chromium.

Alternative energy products sometimes contain agents known to improve athletic performance. These energy products are marketed for the purpose of consuming before exercise. Exemplary agents known to improve athletic performance include, but are not limited to, creatine, which can help increase the effectiveness of a workout, and citrulline, which is a non-essential amino acid that can enhance blood flow during exercise. Unfortunately, both creatine and citrulline may cause stomach discomfort due to bloating. Thus, in various aspects, the composition does not contain an agent known to improve athletic performance (e.g., creatine, citrulline). In a further aspect, the composition does not contain creatine or citrulline.

As detailed elsewhere herein, alternative energy products typically contain a high amount of refined sugar, which is detrimental to human health. High amounts of sugar have contributed to the link between energy products and the development of certain conditions such as type 2 diabetes, obesity, and heart disease. To address this concern, some energy products contain an artificial sweetener or a natural sugar, both of which are alternatives to refined sugars while still imparting a sweet taste. Unfortunately, artificial sweeteners have been linked to a higher risk of stroke and heart disease. Although natural sugars are derived from natural sources, some natural sugars, such as sugar alcohols, can cause digestion issues such as gas, diarrhea, and digestive discomfort. Others, such as stevia extract and monk fruit extract, may impart an undesired aftertaste. Thus, in various aspects, the composition does not contain a sugar (e.g., a natural sugar, an artificial sweetener). In a further aspect, the composition does not contain a natural sugar. In a still further aspect, the composition does not contain inositol. In a yet further aspect, the composition does not contain an artificial sweetener. In a still further aspect, the composition does not contain sucralose, erythritol, or acesulfame potassium.

As detailed herein, the disclosed compositions are beneficially formulated to provide a taste and odor neutral product. Without wishing to be bound by theory, this allows for the composition to be added to any desired beverage without imparting additional taste or odor to the beverage. Thus, in various aspects, the composition does not contain a flavorant (e.g., strawberry). In addition, as disclosed herein, the disclosed compositions are formulated to provide a color neutral product. In a further aspect, the composition does not contain a colorant (e.g., FD&C Blue No. 1).

In various aspects, the composition comprises: (a) a natural caffeine source comprising caffeine and one or more polyphenols, wherein the natural caffeine source is present in an amount of from about 5 wt % to about 75 wt %; (b) one or more antioxidants or sources thereof, wherein the one or more antioxidants or sources thereof are present in an amount of from about 0.5 wt % to about 25 wt %; (c) one or more vitamins or sources thereof, wherein the one or more vitamins or sources thereof are present in an amount of about 25 wt % or less; and (d) one or more additives selected from: (i) one or more electrolytes or sources thereof; and (ii) one or more amino acids or sources thereof, wherein each of the natural caffeine source, the one or more antioxidants or sources thereof, the one or more vitamins or sources thereof, and the one or more additives are different, and wherein the composition comprises 25 wt % or less caffeine.

In various aspects, the composition comprises: (a) a natural caffeine source comprising caffeine and one or more polyphenols, wherein the natural caffeine source is present in an amount of from about 35 wt % to about 55 wt %; (b) one or more antioxidants or sources thereof, wherein the one or more antioxidants or sources thereof are present in an amount of from about 0.5 wt % to about 7.5 wt %; (c) one or more vitamins or sources thereof, wherein the one or more vitamins or sources thereof are present in an amount of about 7.5 wt % or less; and (d) one or more additives selected from: (i) one or more electrolytes or sources thereof; and (ii) one or more amino acids or sources thereof, wherein each of the natural caffeine source, the one or more antioxidants or sources thereof, the one or more vitamins or sources thereof, and the one or more additives are different, and wherein the composition comprises 20 wt % or less caffeine.

In various aspects, the composition comprises: (a) a natural caffeine source comprising caffeine and one or more polyphenols, wherein the natural caffeine source is present in an amount of from about 5 wt % to about 75 wt %; (b) one or more antioxidants or sources thereof, wherein the one or more antioxidants or sources thereof are present in an amount of from about 0.5 wt % to about 25 wt %; (c) one or more vitamins or sources thereof, wherein the one or more vitamins or sources thereof are present in an amount of about 25 wt % or less; and (d) one or more electrolytes or sources thereof, wherein the one or more electrolytes or sources thereof are present in an amount of from about 40 wt % to about 90 wt %, wherein each of the natural caffeine source, the one or more antioxidants or sources thereof, the one or more vitamins or sources thereof, and the one or more electrolytes or sources thereof are different, and wherein the composition comprises 25 wt % or less caffeine.

In various aspects, the composition comprises: (a) a natural caffeine source comprising caffeine and one or more polyphenols, wherein the natural caffeine source is present in an amount of from about 35 wt % to about 55 wt %; (b) one or more antioxidants or sources thereof, wherein the one or more antioxidants or sources thereof are present in an amount of from about 0.5 wt % to about 7.5 wt %; (c) one or more vitamins or sources thereof, wherein the one or more vitamins or sources thereof are present in an amount of about 7.5 wt % or less; and (d) one or more electrolytes or sources thereof, wherein the one or more electrolytes or sources thereof are present in an amount of from about 40 wt % to about 60 wt %, wherein each of the natural caffeine source, the one or more antioxidants or sources thereof, the one or more vitamins or sources thereof, and the one or more electrolytes or sources thereof are different, and wherein the composition comprises 20 wt % or less caffeine.

In various aspects, the composition comprises: (a) a green coffee extract present in an amount of from about 5 wt % to about 75 wt %; (b) ginseng extract in an amount of from about 0.5 wt % to about 25 wt %; (c) one or more vitamins or sources thereof selected from acerola juice or juice extract, vitamin C or a synthetic version or source thereof, vitamin B12 or a synthetic version or source thereof, vitamin B3 or a synthetic version or source thereof, vitamin B3 or a synthetic version or source thereof, vitamin B5 or a synthetic version or source thereof, and vitamin B6 or a synthetic version or source thereof, or a combination thereof, wherein the one or more vitamins or sources thereof are present in an amount of about 25 wt % or less; and (d) one or more electrolytes or sources thereof selected from one or more sodium salts, one or more potassium salts, one or more magnesium salts, one or more calcium salts, and coconut water or water powder, or a combination thereof, wherein the one or more electrolytes or sources thereof are present in an amount of from about 40 wt % to about 90 wt %, wherein each of the natural caffeine source, the one or more antioxidants or sources thereof, the one or more vitamins or sources thereof, and the one or more electrolytes or sources thereof are different, and wherein the composition comprises 25 wt % or less caffeine.

In various aspects, the composition comprises: (a) a green coffee extract in an amount of from about 35 wt % to about 55 wt %; (b) ginseng extract present in an amount of from about 0.5 wt % to about 7.5 wt %; (c) one or more vitamins or sources thereof selected from acerola juice or juice extract, vitamin C or a synthetic version or source thereof, vitamin B12 or a synthetic version or source thereof, vitamin B3 or a synthetic version or source thereof, vitamin B3 or a synthetic version or source thereof, vitamin B5 or a synthetic version or source thereof, and vitamin B6 or a synthetic version or source thereof, or a combination thereof, wherein the one or more vitamins or sources thereof are present in an amount of about 7.5 wt % or less; and (d) one or more electrolytes or sources thereof selected from one or more sodium salts, one or more potassium salts, one or more magnesium salts, one or more calcium salts, and coconut water or water powder, or a combination thereof, wherein the one or more electrolytes or sources thereof are present in an amount of from about 40 wt % to about 60 wt %, wherein each of the natural caffeine source, the one or more antioxidants or sources thereof, the one or more vitamins or sources thereof, and the one or more electrolytes or sources thereof are different, and wherein the composition comprises 20 wt % or less caffeine.

### 1. Natural Caffeine Source

In one aspect, the disclosed compositions comprise a natural caffeine source comprising caffeine and one or more polyphenols. As detailed herein, the disclosed compositions beneficially contain a natural caffeine source that contains low levels of caffeine in combination with one or more polyphenols (e.g., chlorogenic acids, catechins). By selecting to include a natural caffeine source, and, thus, a natural caffeine, the jitteriness that typifies many existing energy beverages, and the crash thereafter, appear to be diminished. In addition, the taste of the resultant composition is also improved, as synthetic caffeine and high caffeine concentrations (e.g., 90 or 95 wt %) can often lead to an artificial taste.

Caffeine is naturally present and can be extracted from the leaves, seeds, and fruits of many plans, including tea leaves, from which green tea and yerba mate extracts can be obtained, and coffee beans, from which green coffee extracts and white coffee can be obtained.

Green tea is made from the leaves of the Camellia sinensis L plant, which is rich in polyphenol catechins and caffeine. Tea is made from the non-, partial, and full fermentation to yield green, oolong, and black tea, respectively. Due to the lack of fermentation, green tea preserves a high quantity of catechin polyphenols. The four main types of catechins are (-)-epigallocatechin-3-gallate (EGCG), (-)-epicatechin-3-gallate, (-)-epigallocatechin (EGC), and (-)-epicatechin. Recent studies have shown that consumption of green tea and green tea extracts, which are a concentrated form of green tea, may provide positive benefits to fat metabolism and fat oxidation during both rest and exercise. Green tea consumption has also been linked to other health benefits, such as prevention of cancer and cardiovascular diseases, as well as having anti-inflammatory, antiarthritic, antibacterial, antiangiogenic, antiviral, neuroprotective, and cholesterol-lowering properties. According to recent studies, many of the aforementioned beneficial effects are attributed largely to the most abundant catechin, EGCG. However, green tea is a complex mixture of various compounds, which are thought to act in a synergistic fashion to exert their full beneficial effects.

In various aspects, the natural caffeine source comprises a green tea extract. As described herein, the green tea extracts can be obtained through any process, and extraction of tea material is well-known in the art. Green tea is typically extracted with hot or cold water to form a dilute extract which contains the solubilized tea compounds. The dilute extract is then concentrated to form the extract, which can be solid in liquid or dried form. Exemplary processes for preparing green tea extracts are disclosed in U.S. Pat. Nos. 5,427,806, 7,981,449, and U.S. Patent Publication No. 2009/0104337, each of which is incorporated herein by reference.

Coffee beans contain high amounts of polyphenols, such as chlorogenic acids. Chlorogenic acids have substantial biological activities, and studies suggest that they may offer a beneficial effect on gluclose regulation and prevention of type 2 diabetes. However, it is known that during the roasting process of coffee beans, these chlorogenic acids are degraded. Green coffee extract, which is an extract of unroasted, green coffee beans, retains these chlorogenic acids while also containing small amounts of caffeine.

In various aspects, the natural caffeine sources comprises a green coffee extract. As described herein, the green coffee extracts can be obtained through any process known in the art. The coffee beans can be subjected to a heat treatment, although such treatments do not reach high enough temperatures to roast the beans.

In contrast to green coffee extracts, white coffee is produced by roasting coffee beans at a lower temperature to produce a “yellow roast” bean. By roasting the coffee beans at a lower temperature, at least some of the beneficial chlorogenic acids in coffee are retained, which are otherwise degraded at the higher temperatures of fully roasted coffee. The flavor of white coffee is frequently described as nutlike, with pronounced acidity.

In various aspects, the natural caffeine source comprises a white coffee. As described herein, the white coffee can be obtained through any process known in the art.

In various aspects, the natural caffeine source is selected from a green tea extract, a green coffee extract, and a white coffee, or a combination thereof. In a yet further aspect, the natural caffeine source comprises a white coffee. In a still further aspect, the natural caffeine source comprises a green coffee extract and a green tea extract. In a yet further aspect, the natural caffeine source comprises a green coffee extract and a white coffee.

In various aspects, the natural caffeine source comprises a green tea extract and a white coffee. In a further aspect, the green tea extract and the white coffee are present in a ratio of from about 1.2:1 to about 2.5:1. The green tea extract and the white coffee can be present, for example, in a ratio of from about 1.2:1 to 2.3:1, 1.2:1 to 2:1, 1.2:1 to 1.5:1, 1.5:1 to 2.5:1, 1.5:1 to 2:1, or from about 2:1 to about 2.5:1. The green tea extract and the white coffee can be present, for example, in a ratio of about 1.2:1, 1.5:1, 1.7:1, 1.9:1, 2:1, or about 2.5:1. In a still further aspect, the green tea extract and the white coffee are present in a ratio of from about 1.2:1, 2:1, or 2.5:1.

As detailed herein, the natural caffeine source comprises one or more polyphenols. Polyphenols are a category of compounds naturally present in plant foods, such as fruits, vegetables, tea, and coffee. Polyphenols have antioxidant properties which may neutralize harmful free radicals and would otherwise increase the risk of diseases such as cancer, diabetes, and heart disease. In various aspects, the one or more polyphenols are selected from chlorogenic acids and catechins. In a further aspect, the one or more polyphenols are chlorogenic acids. In a still further aspect, the one or more polyphenols are catechins (e.g., epigallocatechin gallate (EGCG)).

In various aspects, the natural caffeine source is present in an amount of from about 5 wt % to about 75 wt %. The natural caffeine source can be present, for example, in an amount of from about 5 wt % to 70 wt %, 5 wt % to 65 wt %, 5 wt % to 55 wt %, 5 wt % to 50 wt %, 5 wt % to 45 wt %, 5 wt % to 40 wt %, 5 wt % to 35 wt %, 5 wt % to 30 wt %, 5 wt % to 25 wt %, 5 wt % to 20 wt %, 5 wt % to 15 wt %, 5 wt % to 10 wt %, 10 wt % to 75 wt %, 10 wt % to 70 wt %, 10 wt % to 65 wt %, 10 wt % to 60 wt %, 10 wt % to 55 wt %, 10 wt % to 50 wt %, 10 wt % to 45 wt %, 10 wt % to 40 wt %, 10 wt % to 35 wt %, 10 wt % to 30 wt %, 10 wt % to 25 wt %, 10 wt % to 20 wt %, 10 wt % to 15 wt %, 15 wt % to 75 wt %, 15 wt % to 70 wt %, 15 wt % to 65 wt %, 15 wt % to 60 wt %, 15 wt % to 55 wt %, 15 wt % to 50 wt %, 15 wt % to 45 wt %, 15 wt % to 40 wt %, 15 wt % to 35 wt %, 15 wt % to 30 wt %, 15 wt % to 25 wt %, 15 wt % to 20 wt %, 20 wt % to 75 wt %, 20 wt % to 70 wt %, 20 wt % to 65 wt %, 20 wt % to 60 wt %, 20 wt % to 55 wt %, 20 wt % to 50 wt %, 20 wt % to 45 wt %, 20 wt % to 40 wt %, 20 wt % to 35 wt %, 20 wt % to 30 wt %, 25 wt % to 75 wt %, 25 wt % to 70 wt %, 25 wt % to 65 wt %, 25 wt % to 60 wt %, 25 wt % to 55 wt %, 25 wt % to 50 wt %, 25 wt % to 45 wt %, 25 wt % to 40 wt %, 25 wt % to 35 wt %, 25 wt % to 30 wt %, 30 wt % to 75 wt %, 30 wt % to 70 wt %, 30 wt % to 65 wt %, 30 wt % to 60 wt %, 30 wt % to 55 wt %, 30 wt % to 50 wt %, 30 wt % to 45 wt %, 30 wt % to 40 wt %, 30 wt % to 35 wt %, 35 wt % to 75 wt %, 35 wt % to 70 wt %, 35 wt % to 65 wt %, 35 wt % to 60 wt %, 35 wt % to 55 wt %, 35 wt % to 50 wt %, 35 wt % to 45 wt %, 35 wt % to 40 wt %, 40 wt % to 75 wt %, 40 wt % to 70 wt %, 40 wt % to 65 wt %, 40 wt % to 60 wt %, 40 wt % to 55 wt %, 40 wt % to 50 wt %, 40 wt % to 45 wt %, 45 wt % to 75 wt %, 45 wt % to 70 wt %, 45 wt % to 65 wt %, 45 wt % to 60 wt %, 45 wt % to 55 wt %, 45 wt % to 50 wt %, 50 wt % to 75 wt %, 50 wt % to 70 wt %, 50 wt % to 65 wt %, 50 wt % to 60 wt %, 50 wt % to 55 wt %, 55 wt % to 75 wt %, 55 wt % to 70 wt %, 55 wt % to 65 wt %, 55 wt % to 60 wt %, 60 wt % to 75 wt %, 60 wt % to 70 wt %, 60 wt % to 65 wt %, 65 wt % to 75 wt %, 65 wt % to 70 wt %, or about 70 wt % to about 75 wt %. In some aspects, the natural caffeine source can be present, for example, in an amount of about 5 wt %, 7 wt %, 9 wt %, 10 wt %, 13 wt %, 15 wt %, 17 wt %, 19 wt %, 20 wt %, 22 wt %, 25 wt %, 27 wt %, 30 wt %, 35 wt %, 40 wt %, 45 wt %, 50 wt %, 55 wt %, 60 wt %, 65 wt %, 70 wt %, or about 75 wt %. In some aspects, the natural caffeine source is present in an amount of from about 10 wt % to about 65 wt %. In a further aspect, the natural caffeine source is present in an amount of from about 5 wt % to about 30 wt %. In a yet further aspect, the natural caffeine source is present in an amount of from about 30 wt % to about 60 wt %.

In various aspects, the composition comprises 25 wt % or less caffeine. In some aspects, the composition can comprise, for example, about 22 wt % or less, 20 wt % or less, 18 wt % or less, 15 wt % or less, 13 wt % or less, 10 wt % or less, 8 wt % or less, 6.5 wt % or less, 6 wt % or less, 5.5 wt % or less, 5 wt % or less, 4.5 wt % or less, 4 wt % or less, 3.5 wt % or less, 3 wt % or less, 2.5 wt % or less, 2 wt % or less, 1.5 wt % or less, or about 0.5 wt % or less caffeine. In some aspects, the composition can comprise, for example, about 25 wt % or less, 22 wt % or less, 20 wt % or less, 18 wt % or less, 15 wt % or less, 13 wt % or less, or about 10 wt % or less caffeine. In a further aspect, the composition comprises 22 wt % or less caffeine.

In various aspects, the ratio of the natural caffeine source to the one or more antioxidants or sources thereof is of from about 1:5 to about 150:1. In some aspects, the ratio of the natural caffeine source to the one or more antioxidants or sources there of can be, for example, from about 1:5 to 100:1, 1:5 to 50:1, 1:5 to 10:1, 1:5 to 1:1, 1:1 to 150:1, 1:1 to 100:1, 1:1 to 50:1, 1:1 to 10:1, 10:1 to 150:1, 10:1 to 100:1, 10:1 to 50:1, 50:1 to 150:1, 50:1 to 100:1, or about 100:1 to about 150:1. In some aspects, the ratio of the natural caffeine source to the one or more antioxidants or sources thereof can be, for example, about 1:5, 3:5, 1:1, 10:1, 20:1, 30:1, 40:1, 50:1, 75:1, 100:1, 120:1, or about 150:1.

In various aspects, the ratio of the natural caffeine source to the one or more antioxidants or sources thereof is from about 2:5 to about 65:1. In some aspects, the ratio of the natural caffeine source to the one or more antioxidants or sources thereof can be, for example, from about 2:5 to 65:1, 2:5 to 40:1, 2:5 to 30:1, 2:5 to 20:1, 2:5 to 15:1, 2:5 to 10:1, 2:5 to 1:1, 1:1 to 65:1, 1:1 to 40:1, 1:1 to 30:1, 1:1 to 20:1, 1:1 to 15:1, 1:1 to 10:1, 10:1 to 65:1, 10:1 to 40:1, 10:1 to 30:1, 10:1 to 20:1, 10:1 to 15:1, 15:1 to 65:1, 15:1 to 40:1, 15:1 to 30:1, 15:1 to 20:1, 20:1 to 65:1, 20:1 to 40:1, 20:1 to 30:1, 30:1 to 65:1, 30:1 to 40:1, or about 40:1 to about 65:1.

In various aspects, the ratio of the natural caffeine source to the one or more vitamins or sources thereof is from about 1:5 to about 750:1. In some aspects, the ratio of the natural caffeine source to the one or more vitamins or sources thereof can be, for example, from about 1:5 to 500:1, 1:5 to 300:1, 1:5 to 100:1, 1:5 to 50:1, 1:5 to 10:1, 1:5 to 1:1, 1:1 to 750:1, 1:1 to 500:1, 1:1 to 300:1, 1:1 to 100:1, 1:1 to 50:1, 1:1 to 10:1, 10:1 to 750:1, 10:1 to 500:1, 10:1 to 300:1, 10:1 to 100:1, 10:1 to 50:1, 50:1 to 750:1, 50:1 to 500:1, 50:1 to 300:1, 50:1 to 100:1, 100:1 to 750:1, 100:1 to 500:1, 100:1 to 300:1, 300:1 to 750:1, 300:1 to 500:1, or about 500:1 to about 750:1. In some aspects, the ratio of the natural caffeine source to the one or more vitamins or sources thereof, can be, for example, about 1:5, 1:3, 1:1, 5:1, 10:1, 15:1, 20:1, 50:1, 100:1, 300:1, 500:1, or about 750:1.

In various aspects, the ratio of the natural caffeine source to the one or more vitamins or sources there is from about 1:2 to about 650:1. In some aspects, the ratio of the natural caffeine source to the one or more vitamins or sources thereof can be, for example, from about 1:2 to 500:1, 1:2 to 300:1, 1:2 to 150:1, 1:2 to 100:1, 1:2 to 50:1, 1:2 to 10:1, 1:2 to 1:1, 1:1 to 650:1, 1:1 to 500:1, 1:1 to 300:1, 1:1 to 100:1, 1:1 to 50:1, 1:1 to 10:1, 10:1 to 650:1, 10:1 to 500:1, 10:1 to 300:1, 10:1 to 150:1, 10:1 to 100:1, 10:1 to 50:1, 50:1 to 650:1, 50:1 to 500:1, 50:1 to 300:1, 50:1 to 100:1, 100:1 to 650:1, 100:1 to 500:1, 100:1 to 300:1, 300:1 to 650:1, 300:1 to 500:1, or about 500:1 to about 650:1.

In various aspects, the ratio of the natural caffeine source to the one or more additives is of from about 1:18 to about 15:1. In some aspects, the ratio of the natural caffeine source to the one or more additives can be, for example, from about 1:18 to 10:1, 1:18 to 5:1, 1:18 to 1:1, 1:18 to 1:5, 1:18 to 1:10, 1:10 to 15:1, 1:10 to 10:1, 1:10 to 5:1, 1:10 to 1:1, 1:10 to 1:5, 1:5 to 15:1 1:5 to 10:1, 1:5 to 5:1, 1:5 to 1:1, 1:1 to 15:1, 1:1 to 10:1, 1:1 to 5:1, 5:1 to 15:1, 5:1 to 10:1, or about 10:1 to about 10:15. In some aspects, the ratio of the natural caffeine source to the one or more additives can be, for example, about about 1:18, 1:10, 1:5:1:1, 5:1, 10:1, or about 15:1.

In various aspects, the ratio of the natural caffeine source to the one or more additives is from about 1:15 to about 18:8. The ratio of the natural caffeine source to the one or more additives can be, for example, from about 1:15 to about 2:1, 1:15 to 13:8, 1:15 to 1:1, 1:15 to 1:5, 1:5 to 18:8, 1:5 to 2:1, 1:5 to 13:8, 1:5 to 1:1, 1:1 to 18:8, 1:1 to 2:1, 1:1 to 13:8, 13:8 to 18:8, or from about 13:8 to about 2:1.

In various aspects, the ratio of the natural caffeine source to the one or more additives is from about 2:17 to about 13:1. The ratio of the natural caffeine source to the one or more additives can be, for example, from about 2:17 to about 10:1, 2:17 to 5:1, 2:17 to 3:1, 2:17 to 1:1, 2:17 to 1:5. 1:5 to 13:1, 1:5 to 10:1, 1:5 to 5:1, 1:5 to 3:1, 1:5 to 1:1, 1:1 to 13:1, 1:1 to 10:1, 1:1 to 5:1, or about 5:1 to about 13:1.

In various aspects, the ratio of the natural caffeine source to the one or more additives is from about 1:7 to about 13:9. The ratio of the natural caffeine source to the one or more additives can be, for example, from about 1:7 to 1:1, 1:7 to 1:5, 1:5 to 13:9, or from about 1:5 to about 1:1.

In various aspects, the ratio of the natural caffeine source to the one or more electrolytes is from about 1:18 to about 15:8. The ratio of the natural caffeine source to the one or more electrolytes can be, for example, from about 1:18 to 10:8, 1:18 to 1:1, 1:18 to 1:10, 1:10 to 15:8, 1:10 to 10:8, 1:10 to 1:1, 1:1 to 15:8, 1:1 to 10:8, or about 10:8 to about 15:8. The ratio of the natural caffeine source to the one or more electrolytes can be, for example, about 1:18, 1:10: 1:1, 15:8, or about 15:8.

In various aspects, the ratio of the natural caffeine source to the one or more electrolytes is from about 2:17 to about 13:9. The ratio of the natural caffeine source to the one or more electrolytes can be, for example, from about 2:17 to about 1:1, 2:17 to 10:17, 2:17 to 5:17, 5:17 to 13:9, 5:17 to 1:1, or about 1:1 to 13:9.

In various aspects, the ratio of the natural caffeine source to the one or more amino acids is from about 1:15 to about 15:1. The ratio of the natural caffeine to the one or more amino acids can be, for example, from about 1:15 to 10:1, 1:15 to 5:1, 1:15 to 1:1, 1:15 to 1:10, 1:10 to 15:1, 1:10 to 10:1, 1:10 to 5:1, 1:10 to 1:1, 1:1 to 15:1, 1:1 to 10:1, 1:1 to 5:1, 5:1 to 15:1, 5:1 to 10:1, or about 10:1 to about 15:1. The ratio of the natural caffeine to the one or more amino acids can be, for example, about 1:15, 1:10, 1:5, 1:1, 5:1, 10:1, or about 15:1.

In various aspects, the ratio of the natural caffeine source to the one or more amino acids is from about 1:7 to about 13:1. The ratio of the natural caffeine source to the one or more amino acids can be, for example, from about 1:7 to about 10:1, 1:7 to 5:1, 1:7 to 1:1, 1:7 to 1:5, 1:5 to 13:1, 1:5 to 10:1, 1:5 to 5:1, 1:5 to 1:1, 1:1 to 13:1, 1:1 to 10:1, 1:1 to 5:1, 5:1 to 13:1, 5:1 to 10:1, or about 10:1 to about 13:1.

### 2. Antioxidants

In one aspect, the disclosed compositions comprise one or more antioxidants or sources thereof. As detailed herein, antioxidants are substances that inhibit oxidation, a chemical reaction that can produce harmful free radicals in the body. As such, antioxidants can protext against cell damage caused by free radicals, and consumption of antioxidants has been linked to a decreased risk of developing diseases such as cancer and heart disease. By selecting to include one or more antioxidants or sources thereof, the compositions disclosed herein may provide anti-inflammatory benefits and help improve overall health by reduction of free radicals in the body.

An exemplary source of antioxidants suitable for the compositions disclosed herein is guarana extract. Guarana is a species of climbing plant native to the Amazon and has long been used as a traditional medicine for its antioxidant and stimulant properties. Recent work has found that guarana extract may work as a powerful antioxidant in vivo and exhibit anti-aging properties. In addition to its antioxidant properties, guarana extract has been shown to reduce mental fatigue and improve focus, making it a popular component of energy drink formulations.

A further exemplary source of antioxidants suitable for the compositions disclosed herein is ginseng extract. Ginseng has been used in traditional Chinese medicine for centuries. Research has shown that short-term supplementation with ginseng extract reduced exercise-induced muscle damage and decreased markers of inflammation. Furthermore, ginseng extract may improve brain functions like memory, behavior, and mood. Recent studies have found that regular consumption of ginseng has been associated with improved cognitive function later in life.

A further exemplary source of antioxidants suitable for the compositions disclosed herein is blueberry juice powder. Blueberry juice powder is a fruit powder containing a naturally high amount of antioxidants. Blueberry juice powder has been found to exhibit many health benefits, and is used to promote cardiovascular, immune, brain, and gut health.

In various aspects, the one or more antioxidants or sources thereof are selected from ginger, turmeric, kombucha, pomegranate juice or juice powder, carrot juice or juice powder, orange juice or juice powder, beetroot juice or juice powder, cherry juice or juice powder, guarana extract, ginseng extract, and a berry juice or juice powder (e.g., a blueberry juice or juice powder, a cranberry juice or juice powder), or a combination thereof. In a further aspect, the one or more antioxidants or sources thereof are selected from guarana extract, ginseng extract, and a blueberry juice powder, or a combination thereof. In a yet further aspect, the one or more antioxidants or sources thereof is a combination of guarana extract and ginseng extract. In a still further aspect, the one or more antioxidants or sources thereof is a combination of guarana extract, ginseng extract, and blueberry juice or juice powder.

In various aspects, the one or more antioxidants or sources thereof are present in an amount of from about 0.5 wt % to about 25 wt %. In some aspects, the one or more antioxidants or sources thereof can be present in an amount of, for example, from about 0.5 wt % to 21 wt %, 0.5 wt % to 20 wt %, 0.5 wt % to 15 wt %, 0.5 wt % to 10 wt %, 0.5 wt % to 8 wt %, 0.5 wt % to 6.5 wt %, 0.5 wt % to 6 wt %, 0.5 wt % to 5.5 wt %, 0.5 wt % to 5 wt %, 0.5 wt % to 4.5 wt %, 0.5 wt % to 4 wt %, 0.5 wt % to 3.5 wt %, 0.5 wt % to 3 wt %. 0.5 wt % to 2.5 wt %, 0.5 wt % to 2 wt %, 0.5 wt % to 1.5 wt %, 0.5 wt % to 1 wt %, 1 wt % to 25 wt %, 1 wt % to 21 wt %, 1 wt % to 20 wt %, 1 wt % to 15 wt %, 1 wt % to 10 wt %, 1 wt % to 8 wt %, 1 wt % to 7 wt %, 1 wt % to 6 wt %, 1 wt % to 5 wt %, 1 wt % to 4 wt %, 1 wt % to 3 wt %, 1 wt % to 2 wt %, 2 wt % to 25 wt %, 2 wt % to 21 wt %, 2 wt % to 20 wt %, 2 wt % to 15 wt %, 2 wt % to 10 wt %, 2 wt % to 8 wt %, 2 wt % to 7wt %, 2 wt % to 6 wt %, 2 wt % to 5 wt %, 2 wt % to 4 wt %, 2 wt % to 3 wt %, 3 wt % to 25 wt %, 3 wt % to 21 wt %, 3 wt % to 20 wt %, 3 wt % to 15 wt %, 3 wt % to 10 wt %, 3 wt % to 8 wt %, 3 wt % to 7wt %, 3 wt % to 6 wt %, 3 wt % to 5 wt %, 3 wt % to 4 wt %, 4 wt % to 25 wt %, 4 wt % to 21 wt %, 4 wt % to 20 wt %, 4 wt % to 15 wt %, 4 wt % to 10 wt %, 4 wt % to 8 wt %, 4 wt % to 7 wt %, 4 wt % to 6 wt %, 4 wt % to 5 wt %, 5 wt % to 25 wt %, 5 wt % to 21 wt %, 5 wt % to 20 wt %, 5 wt % to 15 wt %, 5 wt % to 10 wt %, 5 wt % to 8 wt %, 5 wt % to 7 wt %, 5 wt % to 6 wt %, 6 wt % to 25 wt %, 6 wt % to 21 wt %, 6 wt % to 20 wt %, 6 wt % to 15 wt %, 6 wt % to 10 wt %, 5 wt % to 10 wt %, 5 wt % to 8 wt %, 5 wt % to 7 wt %, 7 wt % to 25 wt %, 7 wt % to 21 wt %, 7 wt % to 20 wt %, 7 wt % to 15 wt %, 7 wt % to 10 wt %, 7 wt % to 8 wt %, 8 wt % to 25 wt %, 8 wt % to 21 wt %, 8 wt % to 20 wt %, 8 wt % to 15 wt %, 8 wt % to 10 wt %, 10 wt % to 25 wt %, 10 wt % to 21 wt %, 10 wt % to 20 wt %, 10 wt % to 15 wt %, 15 wt % to 25 wt %, 15 wt % to 21 wt %, 15 wt % to 20 wt %, 20 wt % to 25 wt %, 20 wt % to 21 wt %, or about 21 wt % to 25 wt %. In some aspects, the one or more antioxidants or sources thereof can be present in an amount of, for example, about 0.5 wt %, 1 wt %, 1.5 wt %, 2 wt %, 2.5 wt %, 3 wt %, 3.5 wt %, 4 wt %, 4.5 wt %, 5 wt %, 5.5 wt %, 6 wt %, 6.5 wt %, 7 wt %, 8 wt %, 10 wt %, 15 wt %, 20 wt %, 21 wt %, or about 25 wt %.

In various aspects, the one or more antioxidants or sources thereof are present in an amount of from about 1.0 wt % to about 21 wt %. In some aspects, the one or more antioxidants or sources thereof can be present in an amount of, for example, from about 1 wt % to 20 wt %, 1 wt % to 18 wt %, 1 wt % to 15 wt %, 1 wt % to 13 wt %, 1 wt % to 10 wt %, 1 wt % to 5 wt %, 1 wt % to 4.5 wt %, 1 wt % to 4 wt %, 1 wt % to 3.5 wt %, 1 wt % to 3 wt %, 1 wt % to 2 wt %, 2 wt % to 21 wt %, 2 wt % to 20 wt %, 2 wt % to 18 wt %, 2 wt % to 15 wt %, 2 wt % to 13 wt %, 2 wt % to 10 wt %, 2 wt % to 5 wt %, 2 wt % to 4 wt %, 2 wt % to 3 wt %, 3 wt % to 21 wt %, 3 wt % to 20 wt %, 3 wt % to 18 wt %, 3 wt % to 15 wt %, 3 wt % to 13 wt %, 3 wt % to 10 wt %, 3 wt % to 5 wt %, 3 wt % to 4 wt %, 4 wt % to 21 wt %, 4 wt % to 20 wt %, 4 wt % to 18 wt %, 4 wt % to 15 wt %, 4 wt % to 13 wt %, 4 wt % to 10 wt %, 4 wt % to 5 wt %, 5 wt % to 21 wt %, 5 wt % to 20 wt %, 5 wt % to 18 wt %, 5 wt % to 15 wt %, 5 wt % to 13 wt %, 5 wt % to 10 wt %, 10 wt % to 21 wt %, 10 wt % to 20 wt %, 10 wt % to 18 wt %, 10 wt % to 15 wt %, 10 wt % to 13 wt %, 13 wt % to 21 wt %, 13 wt % to 21 wt %, 13 wt % to 20 wt %, 13 wt % to 18 wt %, 13 wt % to 15 wt %, 15 wt % to 21 wt %, 15 wt % to 20 wt %, 15 wt % to 18 wt %, 18 wt % to 21 wt %, 18 wt % to 20 wt %, or about 20 wt % to about 21 wt %. In some aspects, the one or more antioxidants or sources thereof can be present in an amount of, for example, from about 1 wt %, 1.5 wt %, 2 wt %, 2.5 wt %, 3 wt %, 3.5 wt %, 4 wt %, 4.5 wt %, 5 wt %, 8 wt %, 10 wt %, 13 wt %, 15 wt %, 18 wt %, 20 wt %, or about 21 wt %.

### 3. Vitamins

In one aspect, the disclosed compositions comprise one or more vitamins or sources thereof. As detailed herein, vitamins are organic compounds that are essential to an organism in small amounts for proper metabolic function. There are thirteen vitamins that are essential to maintain proper health: vitamin A, vitamin B1, vitamin B2, vitamin B3, vitamin B5, vitamin B6, vitamin B7, vitamin B9, vitamin B12, vitamin C, vitamin D, vitamin E, and vitamin K. By selecting to include one or more vitamins or sources thereof, the compositions disclosed herein can provide individuals with essential vitamins that are necessary to maintain and improve overall health, and also help prevent vitamin deficiencies.

Vitamins serve diverse biochemical roles. Vitamin A, for example, acts as a regulator of cell and tissue growth and differentiation. The B complex vitamins function as enzyme cofactors. Vitamin B3, or niacin, helps to convert nutrients into energy, create cholesterol and fats, and create and repair DNA. Vitamin B6, or pyridoxine, is important for brain development and maintenance of a health immune and nervous system. Vitamin B12, or cobalamin, plays an essential role in red blood cell production and cell metabolism, and supplementation may improve athletic performance. As a further example, one of the most important roles for vitamin D is to promote calcium absorption in the intestines, thus maintaining and supporting the building of healthy bones.

In various aspects, the one or more vitamins or sources thereof are selected from acerola juice or juice extract, vitamin A or a synthetic version or source thereof, vitamin B or a synthetic version or source thereof (e.g., vitamin B6 or a synthetic version or source thereof, vitamin B12 or a synthetic version or source thereof), vitamin C or a synthetic version or source thereof (e.g., ascorbic acid), vitamin D or a synthetic version or source thereof (e.g., vitamin D3 or a synthetic version or source thereof), and vitamin E or a synthetic version or source thereof, or a combination thereof. In a further aspect, the one or more vitamins or sources thereof are selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof.

In various aspects, the one or more vitamins or sources thereof are present in an amount of about 25 wt % or less. In some aspects, the one or more vitamins or sources thereof can be present at, for example, an amount of about 23 wt % or less, 21 wt % or less, 20 wt % or less, 18 wt % or less, 15 wt % or less, 13 wt % or less, 10 wt % or less, 5 wt % or less, 6.5 wt % or less, 6.0 wt % or less, 5.5% wt% or less, 5.0 wt % or less, 4.5 wt % or less, 4.0 wt % or less, 3.5 wt % or less, 3.0 wt % or less, 2.5 wt % or less, 2.0 wt % or less, 1.5 wt % or less, 1.0 wt % or less, 0.5 wt % or less, or about 0.1 wt % or less. In some aspects, the one or more vitamins or sources thereof can be present at, for example, from about 0.1 to 25 wt %, 0.1 to 20 wt %, 0.1 to 15 wt %, 0.1 to 10 wt %, 0.1 wt % to 7.0 wt %, 0.1 wt % to 6.0 wt %, 0.1 wt % to 5.0 wt %, 0.1 wt % to 4.0 wt %, 0.1 wt % to 3.0 wt %, 0.1 wt % to 2.0 wt %, 0.1 wt % to 1.0 wt %, 1.0 wt % to 7.0 wt %, 1.0 wt % to 6.0 wt %, 1.0 wt % to 5.0 wt %, 1.0 wt % to 4.0 wt %, 1.0 wt % to 3.0 wt %, 1.0 wt % to 2.0 wt %, 2.0 wt % to 7.0 wt %, 2.0 wt % to 6.0 wt %, 2.0 wt % to 5.0 wt %, 2.0 wt % to 4.0 wt %, 2.0 wt % to 3.0 wt %, 3.0 wt % to 7.0 wt %, 3.0 wt % to 6.0 wt %, 3.0 wt % to 5.0 wt %, 3.0 wt % to 4.0 wt %, 4.0 wt % to 7.0 wt %, 4.0 wt % to 6.0 wt %, 4.0 wt % to 5.0 wt %, 5.0 wt % to 7.0 wt %, 5.0 wt % to 6.0 wt %, 10 wt % to 25 wt %, 10 wt % to 20 wt %, 10 wt % to 15 wt %, 15 wt % to 25 wt %, 15 wt % to 20 wt %, or about 20 wt % to about 25 wt %. In a further aspect, the one or more vitamins or sources thereof are present in an amount of from about 0.1 wt % to about 25 wt %. In a still further aspect, the one or more vitamins or sources thereof are present in an amount of from about 0.1 wt % to about 20 wt %. In a yet further aspect, the one or more vitamins or sources thereof are present in an amount of from about 0.1 wt % to about 5 wt %. In a yet still further aspect, the one or more vitamins or sources thereof are present in an amount of from 10 wt % to about 20 wt %. In a still further aspect, the one or more vitamins or sources thereof are present in an amount of about 20 wt % or less. In a still further aspect, the one or more vitamins or sources thereof are present in an amount less than 1.0 wt %.

In various aspects, the composition comprises vitamin B3 or the synthetic version or source thereof. In a further aspect, the vitamin B3 or the synthetic version or source thereof is selected from niacin, niacinamide, and inositol hexanicotinate.

In various aspects, the composition comprises vitamin B6 or the synthetic version or source thereof. In a further aspect, the vitamin B6 or the synthetic version or source thereof is selected from pyridoxine or a salt thereof.

In various aspects, the composition comprises vitamin B12 or the synthetic version or source thereof. a further aspect, the vitamin B12 or the synthetic version or source thereof is selected from natural vitamin B12 and cyanocobalamin.

### 4. Additives

In one aspect, the disclosed compositions comprise one or more additives selected from (i) one or more electrolytes or sources thereof; and (ii) one or more amino acids or sources thereof.

In various aspects, the one or more additives or sources thereof is one or more electrolytes or sources thereof and one or more amino acids.

In various aspects, the one or more additives or sources thereof is present in an amount of from about 0.1 wt % to about 90 wt %. In some aspects, the one or more additives or sources thereof can be present in an amount of, for example, from about 0.1 wt % to 80 wt %, 0.1 wt % to 70 wt %, 0.1 wt % to 60 wt %, 0.1 wt % to 50 wt %, 0.1 wt % to 40 wt %, 0.1 wt % to 30 wt %, 0.1 wt % to 20 wt %, 0.1 wt % to 10 wt %, 0.1 wt % to 5 wt %, 0.1 wt % to 1 wt %, 1 wt % to 90 wt %, 1 wt % to 80 wt %, 1 wt % to 70 wt %, 1 wt % to 50 wt %, 1 wt % to 30 wt %, 1 wt % to 20 wt %, 1 wt % to 15 wt %, 1 wt % to 10 wt %, 1 wt % to 5 wt %, 5 wt % to 90 wt %, 5 wt % to 80 wt %, 5 wt % to 70 wt %, 5 wt % to 60 wt %, 5 wt % to 50 wt %, 5 wt % to 30 wt %, 5 wt % to 20 wt %, 5 wt % to 10 wt %, 10 wt % to 90 wt %, 10 wt % to 80 wt %, 10 wt % to 70 wt %, 10 wt % to 50 wt %, 10 wt % to 30 wt %, 10 wt % to 20 wt %, 20 wt % to 90 wt %, 20 wt % to 70 wt %, 20 wt % to 50 wt %, 20 wt % to 30 wt %, 30 wt % to 90 wt %, 30 wt % to 70 wt %, 30 wt % to 50 wt %, 40 wt % to 90 wt %, 40 wt % to 80 wt %, 40 wt % to 70 wt %, 40 wt % to 60 wt %, 60 wt % to 90 wt %, 60 wt % to 80 wt %, or about 80 wt % to about 90 wt %. In some aspects, the one or more additives or sources thereof can be present in an amount of, for example, about 0.1 wt %, 1 wt %, 2 wt %, 5 wt %, 8 wt %, 10 wt %, 15 wt %, 20 wt %, 25 wt %, 30 wt %, 35 wt %, 40 wt %, 45 wt %, 50 wt %, 65 wt %, 70 wt %, 75 wt %, 80 wt %, 85 wt % or about 90 wt %.

In various aspects, the one or more additives or sources thereof are present in an amount of from 40 wt % to about 90 wt %. The one or more additives or sources thereof can be present, for example, in an amount of from about 40 wt % to 80 wt %, 40 wt % to 70 wt %, 40 wt % to 60 wt %, 40 wt % to 60 wt %, 40 wt % to 50 wt %, 50 wt % to 90 wt %, 50 wt % to 80 wt %, 50 wt % to 70 wt %, 50 wt % to 60 wt %, 60 wt % to 90 wt %, 60 wt % to 80 wt %, 60 wt % to 70 wt %, 70 wt % to 90 wt %, 70 wt % to 80 wt %, or about 80 wt % to about 90 wt %.

In various aspects, the one or more additives or sources thereof are present in an amount of from about 44 wt % to about 83 wt %. The one or more additives or sources thereof can be present, for example, in an amount of from about 44 wt % to 80 wt %, 44 wt % to 70 wt %, 44 wt % to 60 wt %, 44 wt % to 50 wt %, 50 wt % to 83 wt %, 50 wt % to 70 wt %, 50 wt % to 60 wt %, 60 wt % to 83 wt %, 60 wt % to 70 wt %, or about 70 wt % to about 83 wt %.

In various aspects, the one or more additives or sources thereof are present in an amount of from about 0.1 wt % to about 40 wt %. The one or more additives or sources thereof can be present, for example, in an amount of from about 0.1 wt % to 35 wt %, 0.1 wt % to 30 wt %, 0.1 wt % to 25 wt %, 0.1 wt % to 20 wt %, 0.1 wt % to 15 wt %, 0.1 wt % to 10 wt %, 0.1 wt % to 5 wt %, 0.1 wt % to 1 wt %, 1 wt % to 40 wt %, 1 wt % to 30 wt %, 1 wt % to 25 wt %, 1 wt % to 20 wt %, 1 wt % to 15 wt %, 1 wt % to 10 wt %, 1 wt % to 5 wt %, 5 wt % to 40 wt %, 5 wt % to 30 wt %, 5 wt % to 20 wt %, 5 wt % to 10 wt %, 10 wt % to 40 wt %, 10 wt % to 30 wt %, 10 wt % to 20 wt %, 20 wt % to 40 wt %, or about 30 wt % to about 40 wt %.

In various aspects, the one or more additives or sources thereof are present in an amount of from about 0.1 to about 25 wt %. The one or more additives or sources thereof can be present, for example, in an amount of from about 0.1 wt % to 20 wt %, 0.1 wt % to 15 wt %, 0.1 wt % to 10 wt %, 0.1 wt % to 5 wt %, 0.1 wt % to 1 wt %, 1 wt % to 25 wt %, 1 wt % to 20 wt %, 1 wt % to 15 wt %, 1 wt % to 10 wt %, 1 wt % to 5 wt %, 5 wt % to 20 wt %, 5 wt % to 10 wt %, 10 wt % to 25 wt %, 10 wt % to 20 wt %, 10 wt % to 15 wt %, 15 wt % to 25 wt %, 15 wt % to 20 wt %, or about 20 wt % to about 25 wt %.

In various aspects, the one or more additives or sources thereof are present in an amount of from about 0.1 wt % to about 20 wt %. The one or more additives or sources thereof can be present, for example, in an amount of from about 0.1 wt % to about 15 wt %, 0.1 wt % to about 10 wt %, 0.1 wt % to 5 wt %, 0.1 wt % to 1 wt %, 1 wt % to 20 wt %, 1 wt % to 15 wt %, 1 wt % to 10 wt %, 1 wt % to 5 wt %, 5 wt % to 20 wt %, 5 wt % to 20 wt %, 5 wt % to 15 wt %, 5 wt % to 10 wt %, 10 wt % to 20 wt %, 10 wt % to 15 wt %, or about 15 wt % to about 20 wt %.

i. Electrolytes

In various aspects, the one or more additives is one or more electrolytes or sources thereof. As detailed herein, electrolytes are substances that exhibit a net positive or negative electrical charge when dissolved in an aqueous environment. Electrolytes help the body regulate chemical reactions and maintain the balance of fluids inside and outside of cells. Thus, by selecting to include one or more electrolytes or sources thereof, the compositions disclosed herein can help maintain proper hydration levels in an individual and support proper nerve and muscle function.

In various aspects, the one or more electrolytes or sources thereof is selected from one or more sodium salts, one or more potassium salts, one or more magnesium salts, one or more calcium salts, and coconut water or water powder, or a combination thereof. In a yet further aspect, the one or more electrolytes or sources thereof are a combination of one or more sodium salts, one or more potassium salts, one or more magnesium salts, and one or more calcium salts. In a still further aspect, the one or more electrolytes or sources thereof are a combination of one or more sodium salts, one or more potassium salts, and coconut water or water powder.

In various aspects, the one or more electrolytes or sources thereof is present in an amount of from about 40 wt % to about 90 wt %. The one or more electrolytes or sources thereof, for example, can be present in an amount of about 40 wt % to 85 wt %, 40 wt % to 80 wt %, 40 wt % to 70 wt %, 40 wt % to 60 wt %, 40 wt % to 50 wt %, 50 wt % to 90 wt %, 50 wt % to 80 wt %, 50 wt % to 70 wt %, 50 wt % to 60 wt %, 60 wt % to 90 wt %, 60 wt % to 80 wt %, 60 wt % to 80 wt %, 60 wt % to 70 wt %, 70 wt % to 90 wt %, 70 wt % to 80 wt %, or about 80 wt % to about 90 wt %. In some aspects, the one or more electrolyte or sources thereof, for example, can be present in an amount of about 40 wt %, 45 wt %, 50 wt %, 55 wt %, 60 wt %, 65 wt %, 70 wt %, 75 wt %, 80 wt %, 85 wt %, or about 90 wt %. In a further aspect, the one or more electrolytes or sources thereof is present in an amount of about 20 wt %.

In various aspects, the one or more electrolytes or sources thereof is present in an amount of from about 44 wt % to about 83 wt %. The one or more electrolytes or sources thereof, for example, cane be present in an amount of from about 44 wt % to 80 wt %, 44 wt % to 75 wt %, 44 wt % to 70 wt %, 44 wt % to 65 wt %, 44 wt % to 60 wt %, 44 wt % to 50 wt %, 50 wt % to 83 wt %, 50 wt % to 80 wt %, 50 wt % to 75 wt %, 50 wt % to 70 wt %, 50 wt % to 65 wt %, 50 wt % to 60 wt %, 50 wt % to 55 wt %, 55 wt % to 83 wt %, 55 wt % to 80 wt %, 55 wt % to 70 wt %, 55 wt % to 60 wt %, 60 wt % to 83 wt %, 60 wt % to 80 wt %, 60 wt % to 75 wt %, 60 wt % to 70 wt %, 70 wt % to 83 wt %, or about 75 wt % to about 83 wt %.

ii. Amino Acids

In various aspects, the one or more additives is one or more amino acids or sources thereof. As detailed herein, amino acids are molecules that are used by the body as the building blocks to make proteins. Humans need twenty different amino acids to function correctly, with nine of these being considered essential amino acids which must be consumed, as the body cannot synthesize them. Furthermore, ingestion of certain amino acids, such as theanine, has been shown to improve cognitive performance and mood. Thus, by selecting to include one or more amino acids or sources thereof, the compositions disclosed herein can help provide amino acids necessary to maintain proper bodily function. Inclusion of one or more amino acids or sources thereof can provide benefits such as improved mood, improved cognitive performance, higher energy, and maintenance of healthy skin, hair, and nails.

In various aspects, the one or more amino acids or sources thereof are one or more branched amino acids or sources thereof. In a further aspect, the one or more amino acids or sources thereof are selected from theanine, tyrosine, histidine, isoleucine, leucine, lysine, methionine, phenylalanine, threonine, tryptophan, and valine, or a combination thereof. In a still further aspect, the one or more amino acids or sources thereof are selected from theanine, tyrosine, valine, leucine, and isoleucine, or a combination thereof. In a yet further aspect, the one or more amino acids or sources thereof is theanine. In a yet further aspect, the one or more amino acids or sources thereof comprises theanine.

In various aspects, the one or more amino acids or sources thereof are one or more L-amino acids or sources thereof. In a further aspect, the one or more amino acids or sources thereof are selected from L-theanine, L-tyrosine, L-histidine, L-isoleucine, L-leucine, L-lysine, L-methionine, L-phenylalanine, L-threonine, L-tryptophan, and L-valine, or a combination thereof. In a yet further aspect, the one or more amino acids or sources thereof are selected from L-theanine, L-tyrosine, L-valine, L-leucine, and L-isoleucine, or a combination thereof. In a still further aspect, the one or more amino acids or sources thereof is L-theanine. In a yet further aspect, the one or more amino acids or sources thereof is a combination of L-theanine, L-tyrosine, L-isoleucine, L-leucine, and L-valine.

In various aspects, the one or more amino acids or sources thereof is present in an amount of from about 5 wt % to about 75 wt %. In some aspects, the one or more amino acids or sources thereof can be present, for example, in an amount of from about 5 wt % to 70 wt %, 5 wt % to 60 wt %, 5 wt % to 50 wt %, 5 wt % to 40 wt %, 5 wt % to 30 wt %, 5 wt % to 20 wt %, 5 wt % to 10 wt %, 10 wt % to 75 wt %, 10 wt % to 70 wt %, 10 wt % to 60 wt %, 10 wt % to 50 wt %, 10 wt % to 40 wt %, 10 wt % to 30 wt %, 10 wt % to 20 wt %, 20 wt % to 75 wt %, 20 wt % to 70 wt %, 20 wt % to 60 wt %, 20 wt % to 50 wt %, 20 wt % to 40 wt %, 20 wt % to 30 wt %, 30 wt % to 75 wt %, 30 wt % to 70 wt %, 30 wt % to 60 wt %, 30 wt % to 50 wt %, 40 wt % to 75 wt %, 40 wt % to 70 wt %, 40 wt % to 60 wt %, 50 wt % to 75 wt %, 50 wt % to 70 wt %, 50 wt % to 60 wt %, or about 60 wt % to about 75 wt %. In some aspects, the one or more amino acids or sources thereof can be present, for example, in an amount of about 5 wt %, 10 wt %, 20 wt %, 25 wt %, 26 wt %, 27 wt %, 28 wt %, 29 wt %, 30 wt %, 40 wt %, 50 wt %, 60 wt %, 70 wt %, or about 75 wt %.

In various aspects, the one or more amino acids or sources thereof is present in an amount of from about 9 wt % to about 70 wt %. In some aspects, the one or more amino acids or sources thereof can be present, for example, in an amount of from about 9 wt % to 65 wt %, 9 wt % to 60 wt %, 9 wt % to 50 wt %, 9 wt % to 40 wt %, 9 wt % to 30 wt %, 9 wt % to 20 wt %, 9 wt % to 15 wt %, 15 wt % to 70 wt %, 15 wt % to 60 wt %, 15 wt % to 50 wt %, 15 wt % to 40 wt %, 15 wt % to 30 wt %, 15 wt % to 20 wt %, 20 wt % to 70 wt %, 20 wt % to 50 wt %, 20 wt % to 40 wt %, 30 wt % to 70 wt %, 30 wt % to 50 wt %, 40 wt % to 70 wt %, 50 wt % to 70 wt %, 60 wt % to 70 wt %, or about 50 wt % to 60 wt %,

In various aspects, the one or more amino acids or sources thereof is present in an amount of from 55 wt % to 75 wt %. The one or more amino acids or sources thereof, can be present, for example, in an amount of from about 55 wt % to 70 wt %, 55 wt % to 65 wt %, 55 wt % to 60 wt %, 60 wt % to 75 wt %, 60 wt % to 70 wt %, 60 wt % to 65 wt %, 65 wt % to 75 wt %, 65 wt % to 70 wt %, or about 70 wt % to about 75 wt %.

In various aspects, the one or more amino acids or sources thereof is present in an amount of from 5 wt % to about 15 wt %. The one or more amino acids or sources thereof, can be present, for example, in an amount of from about 5 wt % to 13 wt %, 5 wt % to 10 wt %, 5 wt % to 8 wt %, 8 wt % to 15 wt %, 8 wt % to 13 wt %, 8 wt % to 10 wt %, 10 wt % to 15 wt %, 10 wt % to 13 wt %, or about 13 wt % to about 15 wt %.

### 5. Properties

As detailed further herein, the disclosed compositions can have various properties, including high solubility and low turbidity. It is also understood that the disclosed compositions have other properties.

As used herein, the term “solubility” means the ability of a substance, i.e., the solute, to form a solution with a solvent. Thus, in various aspects, the solute can refer to a disclosed composition. In various further aspects, the solvent is water. Solubility can be measured visually such as, for example, by visually comparing the composition (e.g., a composition as disclosed herein) to a reference composition, such as, for example, a reference energy blend composition that is different than the compositions disclosed herein (e.g., a reference energy blend composition that contains a synthetic caffeine source, more than 25 wt % caffeine, and/or tht does not contain each of an antioxidant or source thereof, a vitamin or source thereof, and an additive or source thereof as detailed herein). Thus, in various aspects, a disclosed composition, when in solution, can appear to be at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or at least 99% more soluble than a reference energy blend composition that is different than the compositions disclosed herein.

Turbidity is a measure of the degree to which water loses its transparency due to the presence of suspended particulates. As would be understood by one of skill in the art, a solution with high turbidity appears visibly cloudy or muddy. Turbidity can be measured visually, such as, for example, by visually comparing the composition (e.g., a composition as disclosed herein) to a reference composition, such as, for example, a reference energy blend composition that is different than the compositions disclosed herein (e.g., a reference energy blend composition that contains a synthetic caffeine source, more than 25 wt % caffeine, and/or tht does not contain each of an antioxidant or source thereof, a vitamin or source thereof, and an additive or source thereof as detailed herein). Thus, in various aspects, a disclosed composition, when in solution, can appear to be at least 10%, at least 15%, at least 20%, at least 25%, at least 30%, at least 40%, at least 50%, at least 55%, at least 60%, at least 65%, at least 70%, at least 75%, at least 80%, at least 85%, at least 90%, at least 95%, or at least 99% less turbid than a reference energy blend composition that is different than the compositions disclosed herein.

### C. Liquid Concentrates

In one aspect, disclosed are liquid concentrates comprising water and a disclosed composition. In a further aspect, the composition comprises (a) a natural caffeine source comprising caffeine and one or more polyphenols; (b) one or more antioxidants or sources thereof; (c) one or more vitamins or sources thereof; and (d) one or more additives selected from: (i) one or more electrolytes or sources thereof; and (ii) one or more amino acids or sources thereof, wherein each of the natural caffeine source, the one or more antioxidants or sources thereof, the one or more vitamins or sources thereof, and the one or more additives are different, and wherein the composition comprises 25 wt % or less caffeine.

While it can be possible to add the disclosed composition directly to a beverage, it is generally preferred to first formulate the composition as a liquid concentrate. As would be understood by one of skill in the art, there are a variety of disadvantages to adding a solid and/or suspension directly to a beverage. For example, the solubility of the various components within the composition will depend on the beverage that it is being combined with. Further, the time required for the composition to dissolve can vary widely. Both of these factors, in turn, result in the composition being distributed throughout the beverage, and from beverage to beverage, inconsistently, which gives little control over the end result. By formulating the composition as a liquid concentrate, the amounts of the various components mixed into each beverage can be controlled-which is particularly important for energy beverages.

As disclosed herein, a liquid concentrate refers to a solution or mixture containing one or more of the compositions disclosed herein and a liquid. In various aspects, the liquid is water.

It is generally preferred that the disclosed liquid concentrates are colorless (e.g., color neutral) and odor and flavor neutral so that, upon mixing with a beverage, the color, odor, and/or flavor of the beverage is minimally impacted. However, in various aspects, it can sometimes be desirable to add additional agents to the liquid concentrate so that alternative odors, flavors, and/or colors can be achieved.

Thus, in various aspects, the liquid concentrate further comprises one or more sugars. Sugars suitable for use with the liquid concentrate can include without limitation, sucrose, glucose, fructose, galactose, maltose, dextrose, lactose, maltose, maltodextrin, trehalose, or a combination thereof. In various aspects, the liquid concentrate does not comprise one or more sugars.

In various aspects, the liquid concentrate further comprises one or more natural sugars. Natural sugars suitable for use with the liquid concentrate include without limitation, ethylene glycol, glycerol, erythritol, threitol, arabitol, xylitol, ribitol, mannitol, sorbitol, galactitol, fucitol, iditol, inositol, volemitol, isomalt, maltitol, lactitol, maltotriitol, maltotetraitol, polyglycitol, or a combination thereof. In a further aspect, the one or more natural sugars are inositol. In various aspects, the liquid concentrate does not comprise one or more natural sugars.

In various aspects, the liquid concentrate further comprises one or more artificial sweeteners. Exemplary artificial sweeteners include, but are not limited to, acesulfame potassium, advantame, alitame, aspartame, salts of aspartame-acesulfame, sodium cyclamate, dulcin, glucin, neohesperidin dihidryochalcone, neotame, P-4,000, saccharin, sucralose, brazzein, curculin, fructooligosaccharide, glycyrrhizin, hydrogenated starch hydrolysates, inulin, isomaltooligosaccharide, isomaltulose, lactitol, mogroside mix, mabinlin, maltitol, miraculin, monatin, monellin, osladin, pentadin, polydextrose, psicose, stevia leaf extracts, tagatose, thaumatin, and luo han guo. In a further aspect, the one or more artificial sweeteners are selected from aspartame, acesulfame potassium, erythritol, advantame, neotame, saccharin, luo han guo, and a stevia leaf extract, or a combination thereof. In a still further aspect, the liquid concentrate does not comprise one or more artificial sweeteners.

In various aspects, the liquid concentrate further comprises a flavorant. The flavorant can be derived from any natural or artificial source suitable for use in comestible products. Examples of flavorants suitable for use in the liquid concentrate include, but are not limited to, orange, strawberry, raspberry, cranberry, banana, peach, mango, passion fruit, apple, grape, caramel, watermelon, chocolate, honey flavor, clove, oregano, lemon, lime, jasmine, garlic, ginger, eucalyptus, geranium, dill, cumin, cardamom, cinnamon, acai berry, pineapple, pomegranate, mint, cherry, or a combination thereof. In a further aspect, the liquid concentrate does not comprise a flavorant.

In various aspects, the liquid concentrate further comprises a colorant. The colorant can be derived from any natural of artificial source which is suitable for use in comestible products. The colorant can be derived from a natural source, such as, but not limited to, a carotenoid, chlorophyllin, anthocyanin, betanin, annatto, caramel coloring, carmine, elderberry juice, lycopene, paprika, turmeric, or a combination thereof. The colorant can be derived from an artificial source, such as, but not limited to, FD&C Blue Nos. 1 and 2, FD&C Green No. 3, FD&C Red Nos. 3 and 40, FD&C Yellow Nos. 5 and 6, Orange B, Citrus Red No. 2, or a combination thereof. In a further aspect, the liquid concentrate does not comprise a colorant.

As would be understood by one of skill in the art, a disclosed beverage can be prepared by adding a liquid concentrate (e.g., a liquid concentrate as disclosed herein) to the beverage. It is, therefore, desirable that the energy blend composition, and, thus, the liquid concentrate containing the composition, is neutral in taste, odor, and color so as not to alter or otherwise negatively impact the flavor, odor, and color of the original beverage. It is also desirable that the disclosed composition or liquid concentrate form a stable dispersion when added to a beverage, with sustainable solubility and minimal precipitation of the composition components. Because most beverages have an acidic pH (this is especially true for carbonated beverages due to the dissolved carbon dioxide), it is generally desirable that the pH of the liquid concentrate is either acidic or only mildly basic. Thus, in various aspects, the liquid concentrate has a pH of less than about 6. The liquid concentrate can have a pH of about less than 5.7, less than 5.5, less than 5.2, less than 5, less than 4.7, less than 4.5, less than 4.3, less than 4, less than 3.8, less than 3.5, less than 3.3, or about less than 3.

As it is generally desirable that the pH of the liquid concentrate is either acidic or mildly basic, in various aspects, the liquid concentrate further comprises an acidulant. As detailed herein, an acidulant is a chemical compound that is known in the art to give an acidic, tart, or sour flavor to foods or to enhance the perceived sweetness of foods. Exemplary acidulants suitable for use in the liquid concentrates described herein include, but are not limited to, acetic acid, ascorbic acid, citric acid, fumaric acid, lactic acid, malic acid, phosphoric acid, and tartaric acid.

### D. Beverages

In one aspect, disclosed are beverages comprising the disclosed compositions and/or the disclosed liquid concentrates. Examples of beverages for which the disclosed compositions and disclosed liquid concentrates are particularly well-suited include, but are not limited to, carbonated beverages such as colas, lemon-lime sodas, fruit-flavored sodas, root beers, ginger ales, seltzers, tonic waters, beers, and sparkling waters. Further exemplary beverages for which the disclosed compositions and disclosed liquid concentrates are well-suited include juices, fruit-flavored waters, still waters, teas, and smoothies.

In a further aspect, the composition comprises: (a) a natural caffeine source comprising caffeine and one or more polyphenols; (b) one or more antioxidants or sources thereof; (c) one or more vitamins or sources thereof; and (d) one or more additives selected from: (i) one or more electrolytes or sources thereof; and (ii) one or more amino acids or sources thereof, wherein each of the natural caffeine source, the one or more antioxidants or sources thereof, the one or more vitamins or sources thereof, and the one or more additives are different, and wherein the composition comprises 25 wt % or less caffeine.

In various aspects and as discussed above, a beverage can be prepared by adding a disclosed liquid concentrate to the beverage. In a further aspect, a beverage can be prepared by adding the disclosed composition directly to the beverage.

In various aspects, the beverage is a carbonated beverage. A carbonated beverage, as described herein, refers to a beverage in which dissolved carbon dioxide gas has been added, typically for enhancement of flavor or texture. Carbonated beverages include, but are not limited to, cola, lemon-lime soda, root beer, ginger ale, fruit-flavored sodas, seltzers, tonic water, beers, and sparkling waters. In a further aspect, the carbonated is a carbonated juice or carbonated water.

In a still further aspect, the beverage is a water such as, for example, still water or sparkling water.

In a further aspect, the carbonated beverage is a carbonated juice or a carbonated water.

### E. Kits

In one aspect, disclosed are kits comprising a composition comprising: (a) a natural caffeine source comprising caffeine and one or more polyphenols; (b) one or more antioxidants or sources thereof; (c) one or more vitamins or sources thereof; and (d) one or more additives selected from: (i) one or more electrolytes or sources thereof; and (ii) one or more amino acids or sources thereof, wherein each of the natural caffeine source, the one or more antioxidants or sources thereof, the one or more vitamins or sources thereof, and the one or more additives are different, and wherein the composition comprises 25 wt % or less caffeine, and a beverage.

In various aspects, disclosed are kits comprising a composition consisting essentially of: (a) a natural caffeine source comprising caffeine and one or more polyphenols; (b) one or more antioxidants or sources thereof; (c) one or more vitamins or sources thereof; and (d) one or more additives selected from: (i) one or more electrolytes or sources thereof; and (ii) one or more amino acids or sources thereof, wherein each of the natural caffeine source, the one or more antioxidants or sources thereof, the one or more vitamins or sources thereof, and the one or more additives are different, and wherein the composition comprises 25 wt % or less caffeine, and a beverage.

In various aspects, disclosed are kits comprising a composition consisting of: (a) a natural caffeine source comprising caffeine and one or more polyphenols; (b) one or more antioxidants or sources thereof; (c) one or more vitamins or sources thereof; and (d) one or more additives selected from: (i) one or more electrolytes or sources thereof; and (ii) one or more amino acids or sources thereof, wherein each of the natural caffeine source, the one or more antioxidants or sources thereof, the one or more vitamins or sources thereof, and the one or more additives are different, and wherein the composition comprises 25 wt % or less caffeine, and a beverage.

In various aspects, disclosed are kits comprising a composition comprising: (a) a natural caffeine source selected from a green tea extract, a green coffee extract, and a white coffee, or a combination thereof; (b) one or more antioxidants or sources thereof selected from guarana extract, ginseng extract, and a blueberry juice powder, or a combination thereof; (c) one or more vitamins or sources thereof selected from acerola juice or juice extract, vitamin C or a synthetic version thereof, vitamin B12 or a synthetic version thereof, vitamin B3 or a synthetic version thereof, and vitamin B6 or a synthetic version thereof, or a combination thereof; and (d) one or more additives selected from: (i) one or more electrolytes or sources thereof selected from one or more sodium salts, one or more potassium salts, one or more magnesium salts, one or more calcium salts, and coconut water or water powder, or a combination thereof; and (ii) one or more amino acids or sources thereof selected from L-theanine, L-tyrosine, L-valine, L-leucine, and L-isoleucine, or a combination thereof, and a beverage.

In various aspects, disclosed are kits comprising a composition consisting essentially of: (a) a natural caffeine source selected from a green tea extract, a green coffee extract, and a white coffee, or a combination thereof; (b) one or more antioxidants or sources thereof selected from guarana extract, ginseng extract, and a blueberry juice powder, or a combination thereof; (c) one or more vitamins or sources thereof selected from acerola juice or juice extract, vitamin C or a synthetic version thereof, vitamin B12 or a synthetic version thereof, vitamin B3 or a synthetic version thereof, and vitamin B6 or a synthetic version thereof, or a combination thereof; and (d) one or more additives selected from: (i) one or more electrolytes or sources thereof selected from one or more sodium salts, one or more potassium salts, one or more magnesium salts, one or more calcium salts, and coconut water or water powder, or a combination thereof; and (ii) one or more amino acids or sources thereof selected from L-theanine, L-tyrosine, L-valine, L-leucine, and L-isoleucine, or a combination thereof, and a beverage.

In various aspects, disclosed are kits comprising a composition consisting of: (a) a natural caffeine source selected from a green tea extract, a green coffee extract, and a white coffee, or a combination thereof; (b) one or more antioxidants or sources thereof selected from guarana extract, ginseng extract, and a blueberry juice powder, or a combination thereof; (c) one or more vitamins or sources thereof selected from acerola juice or juice extract, vitamin C or a synthetic version thereof, vitamin B12 or a synthetic version thereof, vitamin B3 or a synthetic version thereof, and vitamin B6 or a synthetic version thereof, or a combination thereof; and (d) one or more additives selected from: (i) one or more electrolytes or sources thereof selected from one or more sodium salts, one or more potassium salts, one or more magnesium salts, one or more calcium salts, and coconut water or water powder, or a combination thereof; and (ii) one or more amino acids or sources thereof selected from L-theanine, L-tyrosine, L-valine, L-leucine, and L-isoleucine, or a combination thereof, and a beverage.

In various aspects, disclosed are kits comprising a composition comprising: (a) natural caffeine source selected from a green tea extract, a green coffee extract, and a white coffee, or a combination thereof; (b) guarana extract and ginseng extract; (c) one or more vitamins or sources thereof selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof; and (d) one or more electrolytes or sources thereof selected from one or more sodium salts, one or more potassium salts, one or more magnesium salts, one or more calcium salts, and coconut water or water powder, or a combination thereof, and a beverage.

In various aspects, disclosed are kits comprising a composition consisting essentially of: (a) natural caffeine source selected from a green tea extract, a green coffee extract, and a white coffee, or a combination thereof; (b) guarana extract and ginseng extract; (c) one or more vitamins or sources thereof selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof; and (d) one or more electrolytes or sources thereof selected from one or more sodium salts, one or more potassium salts, one or more magnesium salts, one or more calcium salts, and coconut water or water powder, or a combination thereof, and a beverage.

In various aspects, disclosed are kits comprising a composition consisting of: (a) natural caffeine source selected from a green tea extract, a green coffee extract, and a white coffee, or a combination thereof; (b) guarana extract and ginseng extract; (c) one or more vitamins or sources thereof selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof; and (d) one or more electrolytes or sources thereof selected from one or more sodium salts, one or more potassium salts, one or more magnesium salts, one or more calcium salts, and coconut water or water powder, or a combination thereof, and a beverage.

In various aspects, disclosed are kits comprising a composition comprising: (a) natural caffeine source selected from a green tea extract, a green coffee extract, and a white coffee, or a combination thereof; (b) one or more antioxidants or sources thereof selected from guarana extract, ginseng extract, and a blueberry juice or juice powder, or a combination thereof; (c) one or more vitamins or sources thereof selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof; and (d) one or more amino acids or sources thereof selected from theanine, tyrosine, isoleucine, leucine, and valine, or a combination thereof, and a beverage.

In various aspects, disclosed are kits comprising a liquid concentrate as disclosed herein and a beverage.

In various aspects, the kit comprises a beverage. In a further aspect, the beverage is a carbonated beverage. Carbonated beverages include, but are not limited to, cola, lemon-lime soda, root beer, ginger ale, fruit-flavored sodas, seltzers, tonic water, beers, and sparkling waters. In a further aspect, the carbonated is a carbonated juice or carbonated water. In a still further aspect, the beverage is a water such as, for example, still water or sparkling water.

It is understood that the disclosed kits can be prepared from the disclosed compounds, products, and compositions. It is also understood that the disclosed kits can be employed in connection with the disclosed methods of using.

The foregoing description illustrates and describes the disclosure. Additionally, the disclosure shows and describes only the preferred embodiments but, as mentioned above, it is to be understood that it is capable to use in various other combinations, modifications, and environments and is capable of changes or modifications within the scope of the invention concepts as expressed herein, commensurate with the above teachings and/or the skill or knowledge of the relevant art. The embodiments described herein above are further intended to explain best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended to the appended claims be construed to include alternative embodiments.

All publications and patent applications cited in this specification are herein incorporated by reference, and for any and all purposes, as if each individual publication or patent application were specifically and individually indicated to be incorporated by reference. In the event of an inconsistency between the present disclosure and any publications or patent application incorporated herein by reference, the present disclosure controls.

### F. Examples

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The Examples are provided herein to illustrate the invention, and should not be construed as limiting the invention in any way. Examples are provided herein to illustrate the invention and should not be construed as limiting the invention in any way.

The disclosed energy compositions contain natural caffeine sources that leverage not only natural caffeine, but also additional compounds having health benefits such as, for example, chlorogenic acids (e.g., from a green coffee extract, 40% caffeine), a roasted white coffee, polyphenolic compounds such as L-theanine, EGCG, and catechins (e.g., from a green tea extract, 40% caffeine). The combination of these compounds is balanced to afford a holistic energy, rather than merely offering an energy jolt as with pure natural caffeine and synthetic caffeine. Additional botanicals that can be used include, but are not limited to, coconut water (e.g., to yield electrolyte salts), acerola seed extract (source of vitamin C), wild blueberry extract (antioxidant), guarana, and ginseng. Upon mixing with a beverage (e.g., water, carbonated water, other carbonated beverage), the disclosed compositions offer enhanced solubility, yielding a clear, dispersible, flavorless solution. The disclosed compositions prevent the interaction of the functional ingredients, and, are, thus, well-suited for acid beverage applications.

### 1. General Approach

The energy blend was formulated to include between 160-180 mg of caffeine per serving (e.g., 25 wt % or less of caffeine based on the total weight of the blend). To this end, three different natural caffeine sources were utilized: (1) a green coffee extract; (2) a green tea extract; and (3) a roasted white coffee. Each source was evaluated either alone or in combination with one another, as further detailed here (see Table 3).

The energy blend was formulated using two different approaches as further detailed herein. Exemplary combinations of components that can be used to target hydration and focus are illustrated in Table 1 and Table 2 below, respectively.

TABLE 1
HYDRATION

| Functional Components | Botanical Components |
|---|---|
| Guarana seed extract | Guarana seed extract |
| Panax ginseng extract | Panax ginseng extract |
| Vitamin B blend | Vitamin B blend |
| Ascorbic acid (vitamin | Acerola juice powder |
| C) | (vitamin C) |
| Electrolyte salts (potassium, | Electrolytes (coconut |
| citrate, calcium lactate, | water powder, potassium |
| magnesium sulfate, sodium | chloride, trisodium citrate) |
| citrate, sodium chloride) | |

TABLE 2
FOCUS APPROACH

| Functional Components | Botanical Components |
|---|---|
| Guarana seed extract | Guarana seed extract |
| Panax ginseng extract | Panax ginseng extract |
| L-Theanine | Acerola juice powder (vitamin C) |
| Vitamin B12 | L-Theanine |
| Amino acid blend (L-tyrosine, L-valine, L- | Vitamin B blend |
| leucine, L-isoleucine) | Wild blueberry juice powder |

Approach 1: Here, the energy blend is formulated with caffeine (e.g., from green coffee extract, green tea extract, and/or white coffee), with additional ingredients supporting hydration, mental focus, and mood boosting. The formulation is further fortified with electrolyte salts such as sodium, potassium, magnesium, and calcium.

Approach 2: Botanical extracts such as coconut water are used to deliver minerals, acerola berry extract is used to deliver Vitamin C, and wild blueberry is used to provide polyphenols. Additional ingredients include a source(s) of natural caffeine, guarana, ginseng, and B-Vitamins.

### 2. Caffeine Blends for Energy Blends

Exemplary natural caffeine sources and blends thereof are shown in Table 3 below. Versions 1-4 were blended to yield 160 mg of caffeine per serving. Comparative Versions 1 and 2 were blended to yield 80 mg of caffeine per serving.

TABLE 3

| | Green Coffee | Green Tea | | | |
|---|---|---|---|---|---|
| | Extract @ | Extract @ | White Coffee | | |
| | 40% caffeine, | 40% caffeine, | @ 5.5% | | |
| | g | g | caffeine, g | | |
| | 80-95% of | 80-95% of | 5-20% | | |
| | caffeine | caffeine | caffeine | | |
| | amount of | amount of | amount of | | |
| | target mg per | target mg per | target mg per | | |
| Blend | serving | serving | serving | Total, g | Caffeine, g |
| Version 1 | 0.36 | 0 | 0.016 | 0.38 | 0.16 |
| Version 2 | 0.4 | 0 | 0 | 0.4 | 0.16 |
| Version 3 | 0 | 0.4 | 0 | 0.53 | 0.16 |
| Version 4 | 0.2 | 0.2 | 0 | 0.4 | 0.16 |
| Version 5 | 0 | 0.36 | 0.016 | 0.38 | 0.16 |
| Version 6 | 0.2 | 0.2 | 0.016 | 0.42 | 0.17 |
| Version 7 | 0.38 | 0 | 0 | 0.38 | 0.15 |
| Comparative | 0.2 | 0 | 0 | 0.2 | 0.080 |
| Version 1 | | | | | |
| Comparative | 0 | 0.2 | 0 | 0.2 | 0.080 |
| Version 2 | | | | | |

### 3. Approach 1—Exemplary Blends

Exemplary blends were prepared by combining the hydration approach (see components above) and Approach 1 (see Table 4A). This blend comprises components that support energy and hydration, as well as offering other mood and health benefits.

TABLE 4A

| | Formulation | Formulation | Formulation | Formulation | |
|---|---|---|---|---|---|
| Component | 1A-1 (g) | 1A-2 (g) | 1A-3 (g) | 1A-4 (g) | |
| Natural | 0.38 (Version | 0.4 (Version | 0.4 (Version | 0.4 (Version | Natural |
| Caffeine | #1) | #2) | #3) | #4) | Caffeine |
| Source | | | | | Source |
| Guarana Seed | 0.020 | 0.020 | 0.020 | 0.020 | Antioxidant |
| Extract | | | | | |
| Ginseng Extract | 0.051 | 0.051 | 0.051 | 0.051 | |
| Sodium Chloride | 0.031 | 0.031 | 0.031 | 0.031 | Electrolytes |
| Trisodium Citrate | 0.17 | 0.17 | 0.17 | 0.17 | |
| Anhydrous | | | | | |
| Tripotassium | 1.43 | 1.43 | 1.43 | 1.43 | |
| Citrate | | | | | |
| Magnesium | 0.24 | 0.24 | 0.24 | 0.24 | |
| Sulfate | | | | | |
| Anhydrous | | | | | |
| Calcium Lactate | 1.06 | 1.06 | 1.06 | 1.06 | |
| Pentahydrate | | | | | |
| Cyanocobalamin | 0.0031 | 0.0031 | 0.0031 | 0.0031 | Vitamins |
| Niacinamide | 0.020 | 0.020 | 0.020 | 0.020 | |
| Pyridoxine | 0.0026 | 0.0026 | 0.0026 | 0.0026 | |
| Hydrochloride | | | | | |
| Ascorbic Acid | 0.11 | 0.11 | 0.11 | 0.11 | |
| (Vitamin C) | | | | | |
| Total | 3.52 | 3.54 | 3.54 | 3.54 | |

| | Formulation | Formulation | Formulation | |
|---|---|---|---|---|
| Component | 1A-5 (g) | 1A-6 (g) | 2A-9 | |
| Natural | 0.38 (Version | 0.42 (Version | 0.38 (Version | Natural |
| Caffeine | #5) | #6) | #7) | Caffeine |
| Source | | | | Source |
| Guarana Seed Extract | 0.020 | 0.020 | — | Antioxidant |
| Ginseng Extract | 0.051 | 0.051 | 0.030 | |
| Sodium Chloride | 0.031 | 0.031 | — | Electrolytes |
| Trisodium Citrate | 0.17 | 0.17 | — | |
| Anhydrous | | | | |
| Trisodium Citrate | — | — | 0.108 | |
| Dihydrate | | | | |
| Tripotassium Citrate | 1.43 | 1.43 | — | |
| Potassium Dihydrogen | — | — | 0.279 | |
| Phosphate | | | | |
| Magnesium Sulfate | 0.24 | 0.24 | — | |
| Anhydrous | | | | |
| Calcium Lactate | 1.06 | 1.06 | — | |
| Pentahydrate | | | | |
| Cyanocobalamin | 0.0031 | 0.0031 | — | Vitamins |
| Niacinamide | 0.020 | 0.020 | — | |
| Pyridoxine Hydrochloride | 0.0026 | 0.0026 | — | |
| Ascorbic Acid (Vitamin C) | 0.11 | 0.11 | — | |
| B-Vitamin blend (B3, B5, | — | — | 0.028 | |
| B6, B12) | | | | |
| Total | 3.52 | 3.56 | 0.82 | |

Additional exemplary blends were prepared by combining the focus approach (see components above) and Approach 1 (see Table 4B). This blend comprises components that support energy and focus, as well as offering other mood and health benefits.

TABLE 4B

| | Formulation | Formulation | Formulation | Formulation | |
|---|---|---|---|---|---|
| Component | 1B-1 (g) | 1B-2 (g) | 1B-3 (g) | 1B-4 (g) | |
| Natural | 0.38 (Version | 0.4 (Version | 0.4 (Version | 0.4 (Version | Natural |
| Caffeine | #1) | #2) | #3) | #4) | Caffeine |
| Source | | | | | Source |
| Guarana Seed | 0.010 | 0.010 | 0.010 | 0.010 | Antioxidant |
| Extract | | | | | |
| Ginseng Extract | 0.051 | 0.051 | 0.051 | 0.051 | |
| L-Theanine | 0.22 | 0.22 | 0.22 | 0.22 | Electrolytes |
| L-Tyrosine | 0.25 | 0.25 | 0.25 | 0.25 | |
| L-Valine | 0.17 | 0.17 | 0.17 | 0.17 | |
| L-Leucine | 0.28 | 0.28 | 0.28 | 0.28 | |
| L-Isoleucine | 0.14 | 0.14 | 0.14 | 0.14 | |
| Cyanocobalamin | 0.0029 | 0.0029 | 0.0029 | 0.0029 | Vitamins |
| Total | 1.50 | 1.52 | 1.52 | 1.52 | |

### 4. Approach 2—Exemplary Blends

Exemplary blends were prepared by combining the hydration approach (see components above) and Approach 2 (see Table 5A). This blend comprises components that support energy, hydration, and mental focus, as well as offering other mood and health benefits.

TABLE 5A

| | Formulation | Formulation | Formulation | Formulation | |
|---|---|---|---|---|---|
| Component | 2A-1 (g) | 2A-2 (g) | 2A-3 (g) | 2A-4 (g) | |
| Natural | 0.38 (Version | 0.4 (Version | 0.4 (Version | 0.4 (Version | Natural |
| Caffeine | #1) | #2) | #3) | #4) | Caffeine |
| Source | | | | | Source |
| Guarana P.E. root | 0.020 | 0.020 | 0.020 | 0.020 | Antioxidant |
| extract | | | | | |
| Panax Ginseng | 0.030 | 0.030 | 0.030 | 0.030 | |
| extract | | | | | |
| B-Vitamin blend | 0.035 | 0.035 | 0.035 | 0.035 | Vitamins |
| Acerola juice | 0.13 | 0.13 | 0.13 | 0.13 | |
| extract | | | | | |
| Coconut Water | 0.52 | 0.52 | 0.52 | 0.52 | Electrolytes |
| Powder | | | | | |
| Potassium | 0.080 | 0.080 | 0.080 | 0.080 | |
| Chloride | | | | | |
| Trisodium Citrate | 0.10 | 0.10 | 0.10 | 0.10 | |
| Total | 1.30 | 1.32 | 1.32 | 1.32 | |

Additional exemplary blends were prepared by combining the focus approach (see components above) and Approach 2 (see Table 5B). This blend comprises components that support energy and mood, as well as offering other focus and health benefits.

TABLE 5B

| | Formulation | Formulation | Formulation | Formulation | |
|---|---|---|---|---|---|
| Component | 2B-1 (g) | 2B-2 (g) | 2B-3 (g) | 2B-4 (g) | |
| Natural | 0.38 (Version | 0.4 (Version | 0.4 (Version | 0.4 (Version | Natural |
| Caffeine | #1) | #2) | #3) | #4) | Caffeine |
| Source | | | | | Source |
| Guarana P.E. root | 0.020 | 0.020 | 0.020 | 0.020 | Antioxidant |
| extract | | | | | |
| Panax Ginseng | 0.03 | 0.03 | 0.03 | 0.03 | |
| extract | | | | | |
| Acerola juice | 0.133 | 0.133 | 0.133 | 0.133 | Vitamins |
| extract | | | | | |
| L-Theanine | 0.102 | 0.102 | 0.102 | 0.102 | |
| B-Vitamin Blend | 0.035 | 0.035 | 0.035 | 0.035 | Electrolytes |
| Wild Blueberry | 0.12 | 0.12 | 0.12 | 0.12 | |
| Juice powder | | | | | |
| Total | 0.82 | 0.84 | 0.84 | 0.84 | |

### 5. Evaluation of Lower Caffeine Levels

Exemplary blends containing lower levels of caffeine (i.e., using Comparative Versions 1 and 2, see Table 3) were prepared by combining the hydration approach (see components above) and either Approach 1 (Table 6A) or Approach 2 (Table 6B).

TABLE 6A

| | Formulation | Formulation | |
|---|---|---|---|
| Component | 1A-7 (g) | 1A-8 (g) | |
| Natural Caffeine Source | 0.2 (Comparative | 0.2 (Comparative | Natural |
| | Version #1) | Version #2) | Caffeine |
| | | | Source |
| Guarana Seed Extract | 0.020 | 0.020 | Antioxidant |
| Ginseng Extract | 0.051 | 0.051 | |
| Sodium Chloride | 0.031 | 0.031 | Electrolytes |
| Trisodium Citrate | 0.17 | 0.17 | |
| Anhydrous | | | |
| Tripotassium Citrate | 1.43 | 1.43 | |
| Magnesium Sulfate | 0.24 | 0.24 | |
| Anhydrous | | | |
| Calcium Lactate | 1.06 | 1.06 | |
| Pentahydrate | | | |
| Cyanocobalamin | 0.0031 | 0.0031 | Vitamins |
| Niacinamide | 0.020 | 0.020 | |
| Pyridoxine Hydrochloride | 0.0026 | 0.0026 | |
| Ascorbic Acid (Vitamin | 0.11 | 0.11 | |
| C) | | | |
| Total | 3.33 | 3.33 | |

TABLE 6B

| | Formulation | Formulation | |
|---|---|---|---|
| Component | 2B-7 (g) | 2B-8 (g) | |
| Natural | 0.2 (Comparative | 0.2 (Comparative | Natural |
| Caffeine | Version #1) | Version #2) | Caffeine |
| Source | | | Source |
| Guarana | 0.02 | 0.02 | Antioxidant |
| P.E. root | | | |
| extract | | | |
| Panax | 0.03 | 0.03 | |
| Ginseng extract | | | |
| B-Vitamin blend | 0.035 | 0.035 | Vitamins |
| Acerola juice extract | 0.13 | 0.13 | |
| Coconut | 0.52 | 0.52 | Electrolytes |
| Water Powder | | | |
| Potassium Chloride | 0.080 | 0.080 | |
| Trisodium Citrate | 0.10 | 0.10 | |
| Total | 1.12 | 1.12 | |

### 6. Optimization of Electrolytes

Energy blends containing alternative combinations of electrolyte salts, and, in particular, alternative combinations of electrolyte salt anions, were prepared to evaluate the impact on solubility and turbidity. The complete formulations and the electrolyte blends evaluated are shown in Table 7 and Table 8, respectively. As noted in the tables, both samples were made with green coffee extract as the natural caffeine source, but with different salt compositions.

TABLE 7

| | Formulation | Formulation | Formulation | Formulation | |
|---|---|---|---|---|---|
| Component | 1A-0 (g) | 1A-4a (g) | 1A-4b (g) | 1A-4c (g) | |
| Natural | 0.4 (Version | 0.4 (Version | 0.4 (Version | 0.4 (Version | Natural |
| Caffeine | #2) | #2) | #2) | #2) | Caffeine |
| Source | | | | | Source |
| Guarana Seed | 0.020 | 0.020 | 0.020 | 0.020 | Antioxidant |
| Extract | | | | | |
| Ginseng Extract | 0.051 | 0.051 | 0.051 | 0.051 | |
| See Table 8. | Blend 1 | Blend 2 | Blend 3 | Blend 4 | Electrolytes |
| Cyanocobalamin | 0.0031 | 0.0031 | 0.0031 | 0.0031 | Vitamins |
| Niacinamide | 0.020 | 0.020 | 0.020 | 0.020 | |
| Pyridoxine | 0.0026 | 0.0026 | 0.0026 | 0.0026 | |
| Hydrochloride | | | | | |
| Ascorbic Acid | 0.11 | 0.11 | 0.11 | 0.11 | |
| (Vitamin C) | | | | | |
| Total | 3.53 | 3.53 | 3.53 | 3.53 | |

TABLE 8
Salt Compositions

| | | Blend 3 | Blend 4 |
|---|---|---|---|
| | | (High Acid Version of | (High Acid Version |
| Blend 1 | Blend 2 | Blend 2) | of Blend 2) |
| 130.0 mg Calcium | 130.0 mg Calcium | Blend 2 + Citric acid | Blend 2 + Citric |
| Lactate | Lactate | | Acid, removal of |
| Pentahydrate | Pentahydrate | | calcium salts and |
| 42.0 mg | 42.0 mg | | addition of L- |
| Magnesium | Magnsium Sulfate | | theanine for |
| Chloride | Anhydrous | | balanced mental |
| Hexahydrate | | | energy |
| 470.0 mg | 470.0 mg | | |
| Dipotassium | Tripotassium | | |
| Phospohate | Citrate | | |
| Anhydrous | Monohydrate | | |
| 10.0 mg Sodium | 10.0 mg Sodium | | |
| Chloride | Chloride | | |
| 40.0 mg Trisodium | 40.0 mg | | |
| Citrate Anhydrous | Trisodium Citrate | | |
| | Anhydrous | | |

Briefly, all samples were prepared the day of tasting by dispersing one serving size per 16 fl oz water. Each sample was evaluated by 5-6 panelists. Samples were tasted at ambient temperatures by the panelist and evaluated on the basis of overall taste profile, flavor impact, linger, and aftertaste. In addition, samples were assessed visually for disperability, color impact, and turbidity.

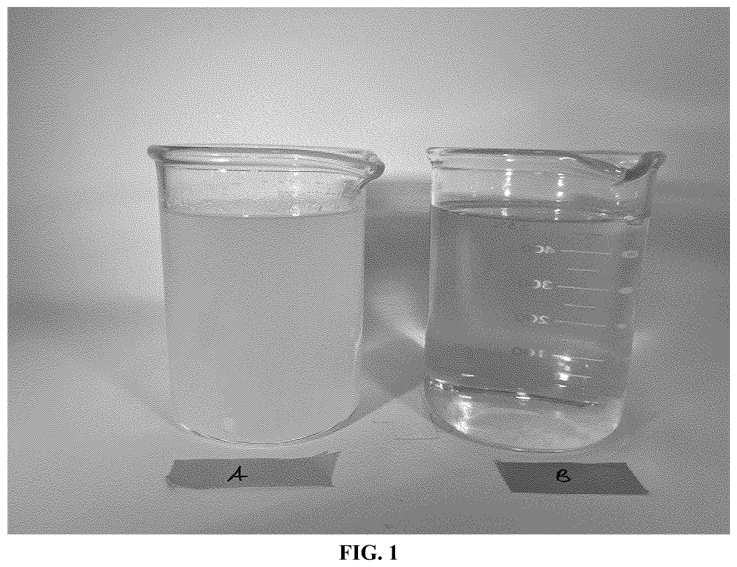

The visual difference in turbidity and solubility between Formulation 1A-0 (Blend 1) and Formulation 1A-4a (Blend 2) is shown in FIG. 1. As shown, Formulation 1A-0 yielded high precipitation and low dispersability. In contrast, Formulation 1A-4a offered significant improvements in both solubility and clarity.

A summary of the differences according to sensory and visual evaluation is provided in Table 9.

TABLE 9

| Sample | Formulation 1A-0 | Formulation 1A-4a |
|---|---|---|
| Overal Sensory | Tasted significantly | Significantly improved |
| Descriptors | salty and inconsistent | taste profile compared |
| | due to solubility issues | to Sample 1 with hint |
| | | of a salty linger |
| Visual Evaluation | High turbidity, low | High solubility without |
| | solubility with | precipitation, clear |
| | significant precipitation | solution |
| | within 15 min of | |
| | dispersion | |

In sum, improvements in solubility and turbidity were observed for Blend 2 compared to Blend 1, in which magnesium chloride was replaced with magnesium sulfate (to prevent interaction of calcium lactate with magnesium chloride, which resulted in precipitation) and in which dipotassium phosphate was replaced with with tripotassium citrate. Blend 3 also incorporates citric acid to achieve a lower pH. Without wishing to be bound by theory, this modification is also expected to improve the flavor and color stability of the finished beverage. Blend 4 incorporates both citric acid and L-theanine, which should further afford balanced mental energy benefits.

### 7. Characterization of Energy Blends

The exemplary formulations were also assessed for their taste profile and subject to visual evaluation. Briefly, samples were prepared the day of tasting by dispersing one serving size per 16 fl oz water. All samples were versions of the 1A hydration energy blends (see Table 4A) and made with Blend 2 of the salt blends above (see Table 8). Each sample was evaluated by 5-6 panelists. Samples were tasted at ambient temperatures by the panelist and evaluated on the basis of overall taste profile, flavor impact, linger, and aftertaste. In addition, samples were assessed visually for disperability, color impact, and turbidity. A summary of the results is detailed in Table 10.

TABLE 10

| | | | | |
|---|---|---|---|---|
| Formulation | Formulation | Formulation | Formulation | Formulation |
| 1A-1 | 1A-5 | 1A-6 | 1A-2 | 1A-3 |

| Overall | Most of the samples were comparable in | Comparable taste of all the |
|---|---|---|
| Sensory | flavor profile with slight grainy notes from | energy blends made with |
| Descriptors | white coffee. Minimal taste impact from | green coffee extract, green |
| | green coffee or green tea extracts or blend of | tea extract, and made with |
| | both with white coffee at 160 mg target | the 1:1 blend of both at 160 |
| | caffeine amount. | mg of target caffeine |
| | | amount. |
| Visual | Dispersible, clear yellowish, with minimal | Easily dispersible with slight |
| Evaluation | impact on color. | yellow tint. Minimal impact |

on color.

| | Formulation 1A-4 | Formulation 1A-7 | Formulation 1A-8 |
|---|---|---|---|
| Overall Sensory | Comparable taste of | Comparable in taste | Comparison in taste |
| Descriptors | all the energy blends | profile with | profile with |
| | made with green | formulation 1A-2. | formulation 1A-3. |
| | coffee extract, green | | |
| | tea extract, and made | | |
| | with the 1:1 blend of | | |
| | both at 160 mg of | | |
| | target caffeine | | |
| | amount. | | |

| | |
|---|---|
| Visual | Dispersible, clear yellowish, with minimal impact on color. |

Evaluation

### G. Prophetic Examples

Additional exemplary blends that can be prepared by combining the focus approach (see components above) with Approach 1 are shown in Table 11.

TABLE 11

| | Formulation | Formulation | |
|---|---|---|---|
| Component | 1B-5 (g) | 1B-6 (g) | |
| Natural | 0.38 (Version | 0.42 (Version | Natural |
| Caffeine | #5) | #6) | Caffeine |
| Source | | | Source |
| Guarana Seed Extract | 0.010 | 0.010 | Antioxidant |
| Ginseng Extract | 0.051 | 0.051 | |
| L-Theanine | 0.22 | 0.22 | Electrolytes |
| L-Tyrosine | 0.25 | 0.25 | |
| L-Valine | 0.17 | 0.17 | |
| L-Leucine | 0.28 | 0.28 | |
| L-Isoleucine | 0.14 | 0.14 | |
| Cyanocobalamin | 0.0029 | 0.0029 | Vitamins |
| Total | 1.50 | 1.54 | |

Additional exemplary blends that can be prepared by combining either the hydration approach or the focus approach (see components above) with Approach 2 are shown in Table 12A and Table 12B, respectively.

TABLE 12A

| | Formulation | Formulation | |
|---|---|---|---|
| Component | 2A-5 (g) | 2A-6 (g) | |
| Natural | 0.38 (Prophetic | 0.42 (Prophetic | Natural |
| Caffeine | Version #1) | Version #2) | Caffeine |
| Source | | | Source |
| Guarana P.E. root extract | 0.020 | 0.020 | Antioxidant |
| Panax Ginseng extract | 0.030 | 0.030 | |
| B-Vitamin blend | 0.035 | 0.035 | Vitamins |
| Acerola juice extract | 0.13 | 0.13 | |
| Coconut Water Powder | 0.52 | 0.52 | Electrolytes |
| Potassium Chloride | 0.080 | 0.080 | |
| Trisodium Citrate | 0.10 | 0.10 | |
| Total | 1.30 | 1.33 | |

TABLE 12B

| | Formulation | Formulation | |
|---|---|---|---|
| Component | 2B-5 (g) | 2B-6 (g) | |
| Natural | 0.38 (Version | 0.4 (Version | Natural |
| Caffeine | #1) | #2) | Caffeine |
| Source | | | Source |
| Guarana P.E. root extract | 0.020 | 0.020 | Antioxidant |
| Panax Ginseng extract | 0.030 | 0.030 | |
| Acerola juice extract | 0.13 | 0.13 | Vitamins |
| L-Theanine | 0.10 | 0.10 | |
| B-Vitamin Blend | 0.035 | 0.035 | Electrolytes |
| Wild Blueberry Juice | 0.12 | 0.12 | |
| powder | | | |
| Total | 0.81 | 0.84 | |

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising:
(a) a natural caffeine source comprising caffeine and one or more polyphenols;
(b) one or more antioxidants or sources thereof;
(c) one or more vitamins or sources thereof; and
(d) one or more additives selected from:
(i) one or more electrolytes or sources thereof; and
(ii) one or more amino acids or sources thereof,
wherein each of the natural caffeine source, the one or more antioxidants or sources thereof, the one or more vitamins or sources thereof, and the one or more additives are different, and
wherein the composition comprises 25 wt % or less caffeine.

2. The composition of claim 1, wherein the natural caffeine source is selected from a green tea extract, a green coffee extract, and a white coffee, or a combination thereof.

3. The composition of claim 2, wherein (i) the green tea extract or the green coffee extract and (ii) the white coffee are present in a ratio of from about 1.2:1 to about 2.5:1.

4. The composition of claim 1, wherein the natural caffeine source is present in an amount of from about 5 wt % to about 75 wt %.

5. The composition of claim 1, wherein the one or more antioxidants or sources thereof are selected from guarana extract, ginseng extract, and a blueberry juice powder, or a combination thereof.

6. The composition of claim 1, wherein the one or more antioxidants or sources thereof are present in an amount of from about 0.5 wt % to about 25 wt %.

7. The composition of claim 1, wherein the one or more vitamins or sources thereof are selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof.

8. The composition of claim 1, wherein the one or more vitamins or sources thereof are present in an amount of about 25 wt % or less.

9. The composition of claim 1, wherein the one or more electrolytes or sources thereof is selected from one or more sodium salts, one or more potassium salts, one or more magnesium salts, one or more calcium salts, and coconut water or water powder, or a combination thereof.

10. The composition of claim 1, wherein the one or more amino acids or sources thereof are selected from L-theanine, L-tyrosine, L-valine, L-leucine, and L-isoleucine, or a combination thereof.

11. The composition of claim 1, wherein the one or more amino acids or sources thereof comprises L-theanine.

12. The composition of claim 1, wherein the composition comprises 22 wt % or less caffeine.

13. The composition of claim 1, wherein the carrier is selected from maltodextrin and dextrose, or a combination thereof.

14. The composition of claim 1, wherein the composition consists essentially of the natural caffeine source, the one or more antioxidants or sources thereof, the one or more vitamins or sources thereof, and the one or more additives.

15. The composition of claim 1, wherein the composition comprises:
(a) the natural caffeine source selected from a green tea extract, a green coffee extract, and a white coffee, or a combination thereof;
(b) guarana extract and ginseng extract;
(c) one or more vitamins or sources thereof selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof; and
(d) one or more electrolytes or sources thereof selected from one or more sodium salts, one or more potassium salts, one or more magnesium salts, one or more calcium salts, and coconut water or water powder, or a combination thereof.

16. The composition of claim 1, wherein the composition comprises:
(a) the natural caffeine source selected from a green tea extract, a green coffee extract, and a white coffee, or a combination thereof;
(b) one or more antioxidants or sources thereof selected from guarana extract, ginseng extract, and a blueberry juice or juice powder, or a combination thereof;
(c) one or more vitamins or sources thereof selected from acerola juice or juice extract, vitamin C or a synthetic version or source thereof, vitamin B12 or a synthetic version or source thereof, vitamin B3 or a synthetic version or source thereof, and vitamin B6 or a synthetic version or source thereof, or a combination thereof; and
(d) one or more amino acids or sources thereof selected from theanine, tyrosine, isoleucine, leucine, and valine, or a combination thereof.

17. The composition of claim 1, wherein the composition does not contain one or more selected from a synthetic caffeine, chromium, citrulline, creatine, inositol, sucralose, erythritol, acesulfame potassium, citicoline, choline, methylliberine, turmeric, rhodiola rosea, schisandra berry, ginger root, a flavorant, and a colorant.

18. A liquid concentrate comprising the composition of claim 1.

19. A beverage comprising the liquid concentrate of claim 18.

20. A beverage comprising the composition of claim 1.
